(19) United States
(12) Patent Application Publication
(10) Pub. No.: US 2025/0318532 A1
(43) Pub. Date: Oct. 16, 2025

(54) ASCAROSIDE COMBINATIONS

(71) Applicant: Ascribe Bioscience Inc., Ithaca, NY (US)

(72) Inventors: Jay Farmer, Ithaca, NY (US); Murli Manohar, Ithaca, NY (US); Wim Dejonghe, Ithaca, NY (US)

(21) Appl. No.: 18/867,965

(22) PCT Filed: May 23, 2023
(86) PCT No.: PCT/US2023/023277

§ 371 Date: Nov. 21, 2024

Related U.S. Application Data
(60) Provisional application No. 63/344,937, filed on May 23, 2022.
(60) Provisional application No. 63/398,745, filed on Aug. 17, 2022.
(60) Provisional application No. 63/421,340, filed on Nov. 1, 2022.
(60) Provisional application No. 63/421,499, filed on Nov. 1, 2022.
(60) Provisional application No. 63/486,018, filed on Feb. 20, 2023.

(51) Int. Cl. A01N 63/12; A01N 37/18; A01N 43/08; A01N 43/10; A01N 43/32; A01N 43/40; A01N 43/56; A01N 43/60; A01N 43/653; A01N 61/00; A01P 3/00; A01P 21/00

(52) U.S. Cl. CPC A01N 63/12; A01N 37/18; A01N 43/08; A01N 43/10; A01N 43/32; A01N 43/40; A01N 43/56; A01N 43/60; A01N 43/653; A01N 61/00; A01P 3/00; A01P 21/00

(57) ABSTRACT

This application relates to combinations of one or more ascarosides with one or more additional active agents (e.g., fungicides). Various combinations can provide enhanced crop protection, with certain combinations surprisingly exhibiting synergy. Various combinations can surprisingly be co-formulated to provide shelf-stable compositions.

### CROSS-REFERENCE TO RELATED APPLICATIONS

This application claims priority to U.S. Provisional Patent Application Serial Nos. 63/344,937 entitled “Ascaroside Combinations,” filed on May 23, 2022; 63/421,340 entitled “Ascarosides and Fungicidal Combinations and Methods for Use,” filed Nov. 1, 2022; 63/421,499 entitled “Ascarosides and Triazole Fungicidal Combinations and Methods for Use,” filed on Nov. 1, 2022; and 63/486,018 entitled “Ascarosides and SDHI Fungicidal Combinations and Methods of Use,” filed on Feb. 20, 2023, which are all incorporated herein by reference in their entireties.

### FIELD OF THE INVENTION

This application generally relates to agrichemical compounds, compositions and methods of treating plants to promote resistance to pathogens.

### BACKGROUND OF THE INVENTION

Ascaroside natural products are secondary metabolites produced by nematodes. A large number of structurally diverse ascarosides have been identified in nature and the molecules are believed to function as an evolutionarily conserved chemical language used by nematodes to control many aspects of their development. Ascarosides are also perceived by other organisms and have been demonstrated to have a range of effects on numerous organisms including bacteria, fungi, plants, and mammals including humans. Ascarosides hold potential as human medicines, agrichemicals and products for other diverse and valuable applications.

Ascaroside treatments have been demonstrated to show efficacy in increasing plant resistance to certain pathogens and/or in inducing and priming plant defense responses (which can inhibit pathogen growth and/or infestation) when applied to the plant. By activating and/or priming plants' innate defenses, ascarosides can thereby prevent proliferation of pathogens and/or protect crops from the damaging effects caused by diverse pathogens.

Agrichemical treatment commonly involves application of more than one active agent to plants and surrounding soil to effectively protect plants from various pathogens. It would be useful to provide further combinations, compositions, and methods which can provide for protection of plants.

### SUMMARY OF THE INVENTION

The disclosure provides compositions and methods involving application of one or more ascarosides in combination with one or more additional active agents to plants. In some embodiments, co-application of one or more ascarosides with one or more additional active agents can provide synergistic effects in plant protection and/or yield. In some embodiments, co-application of one or more ascarosides with one or more additional active agents can comprise applying the components within a single formulation (e.g., a liquid formulation). In some embodiments as described herein, such formulations can be advantageously stable for an extended period of time. This stability is surprising, as formulations comprising more than one active agent often suffer from instability (e.g., manifested as separation, settling, decreased content of active agent relative to starting content, etc.).

The present disclosure includes, without limitation, the following embodiments.

Embodiment 1: A method of enhancing the activity of a fungicide, comprising co-administering to a plant, plant part, or soil surrounding the plant or plant part, the fungicide and one or more ascarosides.

Embodiment 2: The method of Embodiment 1, wherein the fungicide is a biological fungicide.

Embodiment 3: The method of Embodiment 1, wherein the fungicide is a chemical fungicide.

Embodiment 4: The method of Embodiment 3, wherein the chemical fungicide is selected from the group consisting of azoles, strobilurins, carboxamides, nitrogenous heterocyclyl compounds, carbamates and dithiocarbamates, guanidines, antibiotics, organometallic compounds, sulfur-containing heterocyclyl compounds, organophosphorus compounds, organochlorine compounds, nitrophenyl derivatives, inorganic active compounds, and combinations thereof.

Embodiment 5: A method of enhancing the activity of a fungicide, comprising co-administering to a plant, plant part, or soil surrounding the plant or plant part, the fungicide and one or more ascarosides, wherein the fungicide comprises a triazole fungicide.

Embodiment 6: The method of Embodiment 5, wherein the triazole fungicide is prothioconazole or tebuconazole.

Embodiment 7: A method of enhancing the activity of a fungicide, comprising co-administering to a plant, plant part, or soil surrounding the plant or plant part, the fungicide and one or more ascarosides, wherein the fungicide comprises a QₒI fungicide.

Embodiment 8: The method of Embodiment 7, wherein the QₒI fungicide is a strobilurin.

Embodiment 9: The method of Embodiment 8, wherein the strobilurin is selected from the group consisting of Azoxystrobin, Picoxystrobin, Trifloxystrobin, Orysastrobin, Pyraclostrobin, Fenamistrobin, Dimoxystrobin, Fluoxastrobin, Metaminostrobin, Mandestrobin, Pyrametostrobin, Pyrazoxystrobin, Kresoxim-methyl, Fenamidone, or Famoxadone.

Embodiment 10: The method of Embodiment 9, wherein the strobilurin is Azoxystrobin, Picoxystrobin, or Trifloxystrobin.

Embodiment 11: The method of Embodiment 9, wherein the strobilurin is Azoxystrobin.

Embodiment 12: The method of Embodiment 7, wherein the QₒI fungicide is Fenamidone or Famoxadone.

Embodiment 13: A method of enhancing the activity of a fungicide, comprising co-administering to a plant, plant part, or soil surrounding the plant or plant part, the fungicide and one or more ascarosides, wherein the fungicide comprises a SDHI fungicide.

Embodiment 14: The method of Embodiment 13, wherein the SDHI fungicide comprises a benzamide fungicide that inhibits succinate dehydrogenase (SDH) complex II.

Embodiment 15: The method of Embodiment 14, wherein the benzamide fungicide is benodanil, flurenoxadiazam, flutolanil, mebenil, mepronil, fluopyram, benzohydroxamid acid, flumetover, flupicolide, flupimomoide, tioxymid, trichlamide, zarilamid, or zoxamide.

Embodiment 16: The method of Embodiment 13, wherein the SDHI fungicide comprises a carboxamide fungicide that inhibits succinate dehydrogenase (SDH) complex 11.

Embodiment 17: The method of Embodiment 16, wherein the carboxamide fungicide is an oxathiin fungicide.

Embodiment 18: The method of Embodiment 17, wherein the oxathiin fungicide is carboxin or oxycarboxin.

Embodiment 19: The method of Embodiment 16, wherein the carboxamide fungicide is a furan carboxamide fungicide.

Embodiment 20: The method of Embodiment 19, wherein the furan carboxamide fungicide is fenfuram, furcarbanil, or methfuroxam.

Embodiment 21: The method of Embodiment 16, wherein the carboxamide fungicide is a pyrazine carboxamide fungicide.

Embodiment 22: The method of Embodiment 21, wherein the pyrazine carboxamide fungicide is pyraziflumid.

Embodiment 23: The method of Embodiment 16, wherein the carboxamide fungicide is a pyrazole carboxamide fungicide.

Embodiment 24: The method of Embodiment 23, wherein the pyrazole carboxamide fungicide is selected from the group consisting of benzovindiflupyr, bixafen, flubeneteram, fluindapyr, fluxapyroxad, furametpyr, inpyrfluxam, isoflucypram, isopyrazam, penflufen, penthiopyrad, pydiflumetofen, pyrapropoyne, sedaxane, ethaboxam, and thifluzamide

Embodiment 25: The method of Embodiment 16, wherein the carboxamide fungicide is a pyridine carboxamide fungicide.

Embodiment 26: The method of Embodiment 25, wherein the pyridine carboxamide fungicide is boscalid or cyclobutrifluram.

Embodiment 27: The method of Embodiment 13, wherein the SDHI fungicide comprises a thiopheneamide fungicide.

Embodiment 28: The method of Embodiment 27, wherein the thiopheneamide fungicide is isofetamid.

Embodiment 29: The method of any of Embodiments 1-28, providing increased overall yield of the plant.

Embodiment 30: The method of Embodiment 29, wherein the increased overall yield of the plant is greater than yield of a plant treated with the fungicide alone plus yield of a plant treated with the one or more ascarosides alone.

Embodiment 31: The method of any of Embodiments 1-30, providing increased disease protection.

Embodiment 32: The method of Embodiment 31, wherein the increased disease protection is greater than disease protection provided by treatment with the fungicide alone plus disease protection provided by treatment with the one or more ascarosides alone.

Embodiment 33: The method of any of Embodiments 1-32, wherein the co-administering comprises applying the fungicide and the one or more ascarosides in the form of separate formulations.

Embodiment 34: The method of any of Embodiments 1-32, wherein the co-administering comprises applying the fungicide and the one or more ascarosides in the form of a single formulation.

Embodiment 35: The method of Embodiment 34, wherein the formulation is shelf-stable for a period of greater than 6 months.

Embodiment 36: The method of any of Embodiments 1-35, wherein the one or more ascarosides have the structure (I)

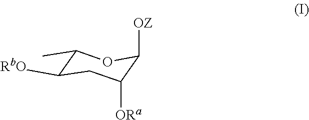

where: Z is an optionally substituted C₂₋₄₀ aliphatic group, and each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g., a moiety —C(O)OR^{c}), a C₂₋₂₀ carbamate (e.g., a moiety —C(O)N(R^{c})₂), a C₂₋₂₀ thioester (e.g., a moiety —C(S)R^{c}), a C₂₋₂₀ thiocarbonate (e.g., a moiety —C(S)OR^{c}), a C₂₋₂₀ dithiocarbonate (e.g., a moiety —C(S)SR^{c}), a C₁₋₂₀ thiocarbamate (e.g., a moiety —C(S)N(R^{c})₂), a sugar moiety, a peptide, a polymer chain, or a linkage via a bond or a carbon-containing linker moiety to another ascaroside molecule, where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

Embodiment 37: The method of Embodiment 36, wherein Z is selected from the group consisting of: (i) —CH(CH₃)—R¹, where R¹ is an optionally substituted C₁₋₄₀ aliphatic group; (ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (iii) —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (iv) CH(CH₃)—(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (v) —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid. a peptide, a nucleotide, or a linkage via a bond or a carbon-containing linker moiety to another ascaroside molecule; (vi) −(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (viii) −(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (viii) —(CH₂)ₙ—CH(OH)—CH—CO₂R², where n is an integer from 1 to 40, and R² is —H, a metal cation, an optionally substituted C₁₋₂0 aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; and (ix) —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule.

Embodiment 38: The method of Embodiment 36, wherein Z is selected from the group consisting of: (x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xii) —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xiii)—CH(CH₃)—(CH₂)ₙ—C(O)—CH—CON(R′)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xiii) —(CH₂)ₙ—CON(R′)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xiv) —(CH₂)₁—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xv) —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; and (xvi) —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

Embodiment 39: The method of any of Embodiments 36-38, wherein R^{a} and R^{b} are each —H.

Embodiment 40: The method of any one of Embodiments 36-39, wherein Z is —CH(CH₃)—(CH₂)ₙ—CO₂R², where n is an integer from 1 to 40, and R² is —H, a metal cation, an optionally substituted C₁₋₂₀ aliphatic group. an optionally substituted aromatic group, a glycoside, an amino acid, a peptide, or a nucleotide.

Embodiment 41: The method of any one of Embodiments 1 to 35, wherein the one or more ascarosides comprise ascr #18.

Embodiment 42: The method of any of Embodiments 1-41, wherein the plant or plant part is selected from a plant or plant part of a crop plant (e.g., corn, alfalfa, sunflower, Brassica, soybean, cotton, safflower, peanut, sorghum, wheat, millet, or tobacco).

Embodiment 43: the method of any of Embodiments 1-42, wherein the activity is activity against plant diseases caused by fungi, viruses or viroids, protozoa, bacteria, and the like (e.g., diseases selected from Asian Soybean Rust (ASR), gray mold, leaf spot, Frogeye Leaf Spot, Early Blight, Damping off complex, Brown Patch, black scurf, root rot, belly rot, sheath blight, Powdery Mildew, Anthracnose leaf spot, Downy Mildew, Pythium Blight, Late Blight, Fusarium Head Blight (FHB), sudden death syndrome (SDS), Fusarium Wilt, Corn Stalk Rot, Brown Rust, Black Rust, Yellow Rust, Wheat Rust, Rust, Apple Scab, Verticillium Wilt, Fire Blight, and Brown Rot).

Embodiment 44: A composition comprising one or more ascarosides and one or more fungicides.

Embodiment 45: The composition of Embodiment 44, wherein the one or more fungicides comprises a biological fungicide.

Embodiment 46: The composition of Embodiment 44, wherein the one or more fungicides comprises a chemical fungicide.

Embodiment 47: The composition of Embodiment 46, wherein the chemical fungicide is selected from the group consisting of azoles, strobilurins, carboxamides, nitrogenous heterocyclyl compounds, carbamates and dithiocarbamates, guanidines, antibiotics, organometallic compounds, sulfur-containing heterocyclyl compounds, organophosphorus compounds, organochlorine compounds, nitrophenyl derivatives, inorganic active compounds, and combinations thereof.

Embodiment 48: A composition comprising one or more ascarosides and one or more fungicides comprising a triazole fungicide.

Embodiment 49: The composition of Embodiment 48, wherein the triazole fungicide is prothioconazole or tebuconazole.

Embodiment 50: A composition comprising at least one ascaroside and one or more fungicides comprising at least one QₒI fungicide.

Embodiment 51: The composition of Embodiment 50, wherein the QₒI fungicide comprises a strobilurin.

Embodiment 52: The composition of Embodiment 51, wherein the strobilurin is selected from the group consisting of Azoxystrobin, Picoxystrobin, Trifloxystrobin, Orysastrobin, Pyraclostrobin, Fenamistrobin, Dimoxystrobin, Fluoxastrobin, Metaminostrobin, Mandestrobin, Pyrametostrobin, Pyrazoxystrobin, Kresoxim-methyl, Fenamidone, and Famoxadone

Embodiment 53: The composition of Embodiment 52, wherein the strobilurin is Azoxystrobin, Picoxystrobin, or Trifloxystrobin.

Embodiment 54: The composition of Embodiment 52, wherein the strobilurin is Azoxystrobin.

Embodiment 55: A composition comprising at least one ascaroside and one or more fungicides comprising a SDHI fungicide.

Embodiment 56: The composition of Embodiment 55, wherein the SDHI fungicide comprises a benzamide fungicide that inhibits succinate dehydrogenase (SDH) complex II.

Embodiment 57: The composition of Embodiment 56, wherein the benzamide fungicide is benodanil, flurenoxadiazam, flutolanil, mebenil, mepronil, fluopyram, benzohydroxamid acid, flumetover, flupicolide, flupimomoide, tioxymid, trichlamide, zarilamid, or zoxamide.

Embodiment 58: The composition of Embodiment 55, wherein the SDHI fungicide comprises a carboxamide fungicide that inhibits succinate dehydrogenase (SDHI) complex 11.

Embodiment 59: The composition of Embodiment 58, wherein the carboxamide fungicide is an oxathiin fungicide.

Embodiment 60: The composition of Embodiment 59, wherein the oxathiin fungicide is carboxin or oxycarboxin.

Embodiment 61: The composition of Embodiment 58, wherein the carboxamide fungicide is a furan carboxamide fungicide.

Embodiment 62: The composition of Embodiment 61, wherein the furan carboxamide fungicide is fenfuram, furcarbanil, or methfuroxam.

Embodiment 63: The composition of Embodiment 58, wherein the carboxamide fungicide is a pyrazine carboxamide fungicide.

Embodiment 64: The composition of Embodiment 63, wherein the pyrazine carboxamide fungicide is pyraziflumid.

Embodiment 65: The composition of Embodiment 58, wherein the carboxamide fungicide is a pyrazole carboxamide fungicide.

Embodiment 66: The composition of Embodiment 65, wherein the pyrazole carboxamide fungicide is selected from the group consisting of benzovindiflupyr, bixafen, flubeneteram, fluindapyr, fluxapyroxad, furametpyr, inpyrfluxam, isoflucypram, isopyrazam, penflufen, penthiopyrad, pydiflumetofen, pyrapropoyne, sedaxane, ethaboxam, and thifluzamide.

Embodiment 67: The composition of Embodiment 58, wherein the carboxamide fungicide is a pyridine carboxamide fungicide

Embodiment 68: The composition of any of Embodiments 44-67, wherein the at least one ascaroside and the fungicide are present in an effective amount, and wherein the effective amount provides synergistic activity in controlling fungal disease.

Embodiment 69: The composition of any of Embodiments 44-68, wherein the one or more ascarosides have the structure (I)

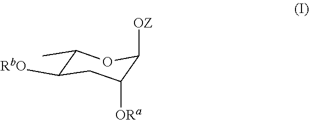

where: Z is an optionally substituted C₃₋₄₀ aliphatic group, and each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{c}), a C₂₋₂₀ carbamate (e.g. -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}). a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule, where R^{o} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

Embodiment 70: The composition of Embodiment 69, wherein Z is selected from the group consisting of: (i) —CH(CH₃)—R¹, where R^{c} is an optionally substituted C₁₋₄₀ aliphatic group; (ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (iii) —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (iv) —CH(CH₃)—(CH₂)ₙ—CH(OH)—CH—CO₂R², where n is an integer from 1 to 40, and R² is —H, a metal cation, an optionally substituted C₁₋₂0 aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (v) —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (vi) —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (vii) —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; (viii) —(CH₂)ₙ—CH(OH)—CH—CO₂R² where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; and (ix) —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide. or a linkage via a bond or a carbon-containing linker moiety to another ascaroside molecule.

Embodiment 71: The composition of claim 69, wherein Z is selected from the group consisting of (x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xi) —CH(CH₃)—(CH₂)—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xii) —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xiii) —CH(CH₃)—(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; (xv) —(CH₂)_{F}—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain. an amino acid, a peptide, a nucleotide, or a linkage via a bond or a carbon-containing linker moiety to another ascaroside molecule; (xvi) —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; and (xvii) —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

Embodiment 72: The composition of any of Embodiments 69-71, wherein R^{a} and R^{b} are each —H.

Embodiment 73: The composition of any one of Embodiments 69-72, wherein Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

Embodiment 74: The composition of any one of Embodiments 44-68, wherein the one or more ascarosides comprise ascr #18.

Embodiment 75: The composition of any of Embodiments 44-74, in solid form.

Embodiment 76: The composition of Embodiment 75, wherein the solid form comprises powder or granules.

Embodiment 77: The composition of any of Embodiments 44-74, in liquid form.

Embodiment 78: The composition of Embodiment 77, wherein the liquid form is a sprayable formulation.

Embodiment 79: The composition of Embodiment 77 or 78, wherein the composition is shelf-stable for a period of greater than 6 months or greater than 12 months.

Embodiment 80: The composition of any of Embodiments 44-79, further comprising one or more additional components selected from the group consisting of surfactants, including emulsifiers, dispersants, foam-formers, colorants, processing aids, lubricants, fillers, reinforcements, flame retardants, light stabilizers, ultraviolet radiation absorbers, weather stabilizers, plasticizers, release agents, perfumes, heat-retaining additives (e.g., silica), cross-linking agents, antioxidants, anti-foaming agents, buffers, pH modifiers, compatibility agents, drift control additives, extenders/stickers, tackifiers, plant penetrants, safeners, spreaders, and wetting agents.

Embodiment 81: The composition of any of Embodiments 44-80, wherein the fungicide and the ascaroside are present in a weight ratio of greater than 1000:1, greater than 1500:1, greater than 2000:1, greater than 3000:1, greater than 5000:1, or greater than 10,000:1 fungicide:ascaroside.

Embodiment 82: The composition of any of Embodiments 44-81, labeled for application to crops at a rate lower than a label rate of the fungicide alone.

Embodiment 83: The composition of any of Embodiments 44-82, labeled for application to crops at a rate that delivers less than 4 oz, less than 3 oz, or less than 2.5 oz fungicide per acre.

These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise. Other aspects and advantages of the present disclosure will become apparent from the following.

### BRIEF DESCRIPTION OF THE DRAWINGS

The present teachings described herein will be more fully understood from the following description of various illustrative embodiments, when read together with the accompanying drawings. It should be understood that each drawing described below is for illustration purposes only and is not intended to limit the scope of the present teachings in any way. The foregoing and other objects, aspects, features, and advantages of the disclosure will become more apparent and may be better understood by referring to the following description taken in conjunction with the accompanying drawings, in which:

FIG. 1 provides data on a non-limiting combinations of an ascaroside with a triazole fungicide;

FIG. 2 is a chart of disease severity measurements obtained from a growth chamber/greenhouse experiment with spring wheat scored for spot blotch symptoms (Bipolaris sorokiniana), treated with ascarosides (PHYTALIX®) in combination with a generic class 3 fungicide, Tebuconazole, compared with solo treatments of each product and an untreated control (Mock).

FIG. 3 is a chart of disease severity measurements obtained from a field trial in which spring wheat was scored for fusarium head blight symptoms (FHB) after treatment with ascarosides (PHYTALIX®, 25 mg/ac) in combination with label rate application of two triazole fungicides (Prothioconazole and Tebuconazole) compared to treatments with ascarosides only or Prothioconazole and Tebuconazole only, and untreated control (Mock);

FIG. 4 is a chart of disease severity measurements obtained from a field trial in which wheat was scored for Septoria Leaf Blotch severity after treatment with ascarosides (PHYTALIX® 25 mg/ac) in combination with label rate application of Prothioconazole compared to treatments with ascarosides only or Prothioconazole only or an untreated control (Mock);

FIG. 5 is charts of Fusarium Head Blight disease index obtained from a field trial in which wheat was treated with ascarosides (PHYTALIX® 25 mg/ac) in combination with label rate application of propiconazole and Pydiflumetofen compared to treatments with ascarosides only or propiconazole and Pydiflumetofen only or an untreated control (Mock);

FIG. 6 is a chart of disease severity measurements obtained from a field trial in which wheat was scored for fusarium head blight symptoms (FHB) after treatment with ascarosides (PHYTALIX® 25 mg/ac) in combination with label rate application of Prothioconazole compared to treatments with ascarosides only or Prothioconazole only or untreated control (Mock);

FIG. 7 is soybean yield data for ascaroside treatments and control treatments from a soybean field trial in Brazil where ASR was present;

FIG. 8 shows soybean yield data for ascaroside treatments and control treatments from a second soybean field trial site in Brazil where ASR was present;

FIG. 9 shows ASR disease scoring from a soybean field trial site in Brazil treated with ascarosides and controls;

FIG. 10 shows photographs of representative leaves from soybean plants treated with a combination of ascaroside and conventional fungicides or treated only with conventional fungicides from a field trial site in Brazil where ASR was present;

FIG. 11 shows results of a field trial with soybeans scored for Asian soybean rust (ASR) and tested for synergy of PHYTALIX® in combination with a fungicide containing the QₒI fungicide Picoxystrobin and the class M05 fungicide Chlorothalonil (left graph). Right graph depicts the corresponding yield for the field trial. Fungicide applied at label rate. PHYTALIX® at 10 μM (205 mg/acre). Error bars indicate the standard error of the mean. [symbol] =P≤0.05 and [symbol] [symbol] [symbol] [symbol] =P≤0.0001 for a one-way ANOVA with Tukey's multiple comparisons test; [symbol] Text use z, 23 fsi

FIG. 12 shows a chart of disease severity measurements obtained from a field trial in which soybean was inoculated with Asian Soybean Rust and scored for disease symptoms (FHB) after treatment with ascarosides (50 mg/ac) in combination with label rate application azoxystrobin (Azoxy), compared to: treatments with ascarosides only (PHYTALIX®); a combination treatment of ascarosides and azoxystrobin; and TRIVAPRO™, a commercial fungicide containing a 3-way blend of Propiconazole, Azoxystrobin, and Benzovindiflupyr;

FIG. 13 shows a chart of soybean yield from the trial described in FIG. 12;

FIG. 14 shows a chart of “Spot Blotch” disease symptoms in wheat (caused by the fungal pathogen Bipolaris sorokiniana) comparing untreated control (Mock) to treatment with azoxystrobin alone at 1/20th of the label application rate (Azoxystrobin); treatment with an ascaroside formulation (PHYTALIX®) alone at 25 mg/acre equivalent and treatment with the combination of azoxystrobin and ascaroside;

FIG. 15 shows a chart of “Spot Blotch” disease symptoms in wheat (caused by the fungal pathogen Bipolaris sorokiniana) comparing untreated control (Mock) to treatment with Fluxapyraxid (an SDHI fungicide); treatment with an ascaroside formulation (PHYTALIX®) alone at 25 mg/acre equivalent and treatment with the combination of Fluxapyraxid and ascaroside;

FIG. 16 shows a chart of bacterial leaf streak incidence in field trial plots of wheat grown from untreated seeds (Mock), seeds treated with ascarosides (PHYTALIX®), seeds treated with chemical fungicides (Apron Maxx™), and seeds treated with ascarosides and chemical fungicides (PHYTALIX®+Apron Maxx);

FIG. 17. shows a chart of the stay green effect in field trial plots of corn grown from untreated seeds (Mock), seeds treated with ascarosides (PHYTALIX®), seeds treated with chemical fungicides (Cruiser Maxx™), and seeds treated with both ascarosides and chemical fungicides (PHYTALIX®+Cruiser Maxx™; and

FIG. 18 shows a chart of seedling stand count measured in soybean field trial plots planted with untreated seeds (Mock), seeds treated with ascarosides (PHYTALIX®), seeds treated with chemical fungicides (Apron Maxx™), and seeds treated with ascarosides and chemical fungicides (PHYTALIX®+Apron Maxx™)

### DEFINITIONS

In order for the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

As used herein, the terms “about” and “approximately” are used as equivalents. Unless otherwise stated, the terms “about” and “approximately” may be understood to permit standard variation as would be understood by those of ordinary skill in the art. Where ranges are provided herein, the endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito, 1999; Smith and March March's Advanced Organic Chemistry, 5^{th} Edition, John Wiley & Sons, Inc., New York, 2001; Larock, Comprehensive Organic Transformations, VCH Publishers, Inc., New York, 1989; Carruthers, Some Modern Methods of Organic Synthesis, 3^{rd} Edition, Cambridge University Press, Cambridge, 1987; the entire contents of each of which are incorporated herein by reference.

Certain compounds provided herein can comprise one or more asymmetric centers, and thus can exist in various stereoisomeric forms, e.g., enantiomers and/or diastereomers. Thus, inventive compounds and compositions thereof may be in the form of an individual enantiomer, diastereomer or geometric isomer, or may be in the form of a mixture of stereoisomers. In certain embodiments, compounds described herein are enantiopure compounds. In certain other embodiments, mixtures of enantiomers or diastereomers are provided.

Furthermore, certain compounds as described herein may have one or more double bonds that can exist as either a Z or E isomer, unless otherwise indicated. The compounds can be provided as individual isomers substantially free of other isomers and alternatively, as mixtures of various isomers, e.g., racemic mixtures of enantiomers.

As used herein, the term “isomers” includes any and all geometric isomers and stereoisomers. For example, “isomers” include cis- and trans-isomers, E- and Z-isomers, R- and S-enantiomers, diastereomers, (D)-isomers, (L)-isomers, racemic mixtures thereof, and other mixtures thereof, as falling within the scope of the disclosure. For instance, a compound may, in some embodiments, be provided substantially free of one or more corresponding stereoisomers, and may also be referred to as “stereochemically enriched.”

Where a particular enantiomer is preferred, it may, in some embodiments be provided substantially free of the opposite enantiomer, and may also be referred to as “optically enriched.” “Optically enriched,” as used herein, means that the compound is made up of a significantly greater proportion of one enantiomer. In certain embodiments the compound is made up of at least about 90% by weight of an enantiomer. In some embodiments the compound is made up of at least about 95%, 97%, 98%, 99%, 99.5%, 99.7%, 99.8%, or 99.9% by weight of an enantiomer. In some embodiments the enantiomeric excess of provided compounds is at least about 90%, 95%, 97%, 98%, 99%, 99.5%, 99.7%, 99.8%, or 99.9%. In some embodiments, enantiomers may be isolated from racemic mixtures by any method known to those skilled in the art, including chiral high pressure liquid chromatography (HPLC) and the formation and crystallization of chiral salts or prepared by asymmetric syntheses. See, for example, Jacques, et al., Enantiomers, Racemates and Resolutions (Wiley Interscience, New York, 1981); Wilen, S. H., et al., Tetrahedron 33:2725 (1977); Eliel, E. L. Stereochemistry of Carbon Compounds (McGraw-Hill, NY, 1962); Wilen, S. H. Tables of Resolving Agents and Optical Resolutions p. 268 (E. L. Eliel, Ed., Univ. of Notre Dame Press, Notre Dame, IN 1972).

The terms “halo” and “halogen” as used herein refer to an atom selected from fluorine (fluoro, —F), chlorine (chloro, —Cl), bromine (bromo, —Br), and iodine (iodo, —I).

The term “aliphatic” or “aliphatic group”, as used herein, denotes a hydrocarbon moiety that may be straight-chain (i.e., unbranched), branched, or cyclic (including fused, bridging, and spiro-fused polycyclic) and may be completely saturated or may contain one or more units of unsaturation, but which is not aromatic. Unless otherwise specified, aliphatic groups contain 1-30 carbon atoms. In certain embodiments, aliphatic groups contain 1-12 carbon atoms. In certain embodiments, aliphatic groups contain 1-8 carbon atoms. In certain embodiments, aliphatic groups contain 1-6 carbon atoms. In some embodiments, aliphatic groups contain 1-5 carbon atoms, in some embodiments, aliphatic groups contain 1-4 carbon atoms, in yet other embodiments aliphatic groups contain 1-3 carbon atoms, and in yet other embodiments aliphatic groups contain 1-2 carbon atoms. Suitable aliphatic groups include, but are not limited to, linear or branched, alkyl, alkenyl, and alkynyl groups, and hybrids thereof such as (cycloalkyl)alkyl, (cycloalkenyl)alkyl or (cycloalkyl)alkenyl.

The term “heteroaliphatic” or “heteroaliphatic group”, as used herein, denotes an aliphatic group where one or more carbon or hydrogen atoms are replaced by a heteroatom (e.g. oxygen, nitrogen, sulfur, phosphorous, boron, etc.).

The term “unsaturated”, as used herein, means that a moiety has one or more double or triple bonds.

The term “alkyl,” as used herein, refers to saturated, straight- or branched-chain hydrocarbon radicals derived from an aliphatic moiety containing between one and six carbon atoms by removal of a single hydrogen atom. Unless otherwise specified, alkyl groups contain 1-12 carbon atoms. In certain embodiments, alkyl groups contain 1-8 carbon atoms. In certain embodiments, alkyl groups contain 1-6 carbon atoms. In some embodiments, alkyl groups contain 1-5 carbon atoms, in some embodiments, alkyl groups contain 1-4 carbon atoms, in yet other embodiments alkyl groups contain 1-3 carbon atoms, and in yet other embodiments alkyl groups contain 1-2 carbon atoms. Examples of alkyl radicals include, but are not limited to, methyl, ethyl, n-propyl, isopropyl, n-butyl, iso-butyl, sec-butyl, sec-pentyl, iso-pentyl, tert-butyl, n-pentyl, neopentyl, n-hexyl, sec-hexyl, n-heptyl, n-octyl, n-decyl, n-undecyl, dodecyl, and the like.

The term “alkenyl,” as used herein, denotes a monovalent group derived from a straight- or branched-chain aliphatic moiety having at least one carbon-carbon double bond by the removal of a single hydrogen atom. Unless otherwise specified, alkenyl groups contain 2-12 carbon atoms. In certain embodiments, alkenyl groups contain 2-8 carbon atoms. In certain embodiments, alkenyl groups contain 2-6 carbon atoms. In some embodiments, alkenyl groups contain 2-5 carbon atoms, in some embodiments, alkenyl groups contain 2-4 carbon atoms, in yet other embodiments alkenyl groups contain 2-3 carbon atoms, and in yet other embodiments alkenyl groups contain 2 carbon atoms. Alkenyl groups include, for example, ethenyl, propenyl, butenyl, 1-methyl-2-buten-1-yl, and the like.

The term “aryl” used alone or as part of a larger moiety as in “aralkyl”, “aralkoxy”, or “aryloxyalkyl”, refers to monocyclic and polycyclic ring systems having a total of five to 20 ring members, wherein at least one ring in the system is aromatic and wherein each ring in the system contains three to twelve ring members. The term “aryl” may be used interchangeably with the term “aryl ring”. In certain embodiments, “aryl” refers to an aromatic ring system which includes, but is not limited to, phenyl, biphenyl, naphthyl, anthracyl and the like, which may bear one or more substituents. Also included within the scope of the term aryl”, as it is used herein, is a group in which an aromatic ring is fused to one or more additional rings, such as benzofuranyl, indanyl, phthalimidyl, naphthimidyl, phenanthridinyl, or tetrahydronaphthyl, and the like.

As described herein, compounds as provided herein may contain “optionally substituted” moieties. In general, the term “substituted”, whether preceded by the term “optionally” or not, means that one or more hydrogens of the designated moiety are replaced with a suitable substituent. Unless otherwise indicated, an “optionally substituted” group may have a suitable substituent at each substitutable position of the group, and when more than one position in any given structure may be substituted with more than one substituent selected from a specified group, the substituent may be either the same or different at every position. Combinations of substituents envisioned are preferably those that result in the formation of stable or chemically feasible compounds. The term “stable,” as used herein, refers to compounds that are not substantially altered when subjected to conditions to allow for their production, detection, and, in certain embodiments, their recovery, purification, and use for one or more of the purposes disclosed herein.

Suitable monovalent substituents on a substitutable carbon atom of an “optionally substituted” group are independently halogen; —(CH₂)₀₋₄R^{∘}; —(CH₂)₀₋₄OR^{∘}; —O—(CH₂)₀₋₄C(O)OR^{∘}; —(CH₂)₀₋₄CH(OR^{∘})₂; —(CH₂)₀₋₄SR^{∘}; —(CH₂)₀₋₄Ph, which may be substituted with R^{∘}; —(CH₂)₀₋₄O(CH₂)₀₋₁Ph which may be substituted with R^{∘}; —CH═CHPh, which may be substituted with R^{∘}; —NO₂; —CN; —N₃; —(CH₂)₀₋₄N(R^{∘})₂; —(CH₂)₀₋₄N(R^{∘})C(O)R^{∘}; —N(R^{∘})C(S)R^{∘}; —(CH₂)₀₋₄N(R^{∘})C(O)NR^{∘}₂; —N(R^{∘})C(S)NR^{∘}₂; —(CH₂)₀₋₄N(R^{∘})C(O)OR^{∘}; —N(R^{∘})N(R^{∘})C(O)R^{∘}; —N(R^{∘})N(R^{∘})C(O)NR^{∘}₂; —N(R^{∘})N(R^{∘})C(O)OR^{∘}; —(CH₂)₀₋₄C(O)R^{∘}; —C(S)R^{∘}; —(CH₂)₀₋₄C(O)OR^{∘}; —(CH₂)₀₋₄C(O)N(R^{∘})₂; —(CH₂)₀₋₄C(O)SR^{∘}; —(CH₂)₀₋₄C(O)OSiR^{∘}₃; —(CH₂)₀₋₄OC(O)R^{∘}; —OC(O)(CH₂)₀₋₄SR—, SC(S)SR^{∘}; —(CH₂)₀₋₄SC(O)R^{∘}; —(CH₂)₀₋₄C(O)NR^{∘}₂; —C(S)NR^{∘}₂; —C(S)SR^{∘}; —SC(S)SR^{∘}, —(CH₂)₀₋₄OC(O)NR^{∘}₂; —C(O)N(OR^{∘})R^{∘}; —C(O)C(O)R^{∘}; —C(O)CH₂C(O)R^{∘}; —C(NOR^{∘})R^{∘}; —(CH₂)₀₋₄SSR^{∘}; —(CH₂)₀₋₄S(O)₂R^{∘}; —(CH₂)₀₋₄S(O)₂OR^{∘}; —(CH₂)₀₋₄OS(O)₂R^{∘}; —S(O)₂NR^{∘}₂; —(CH₂)₀₋₄S(O)R^{∘}; —N(R^{∘})S(O)₂NR^{∘}₂; —N(R^{∘})S(O)₂R^{∘}; —N(OR^{∘})R^{∘}; —C(NH)NR^{∘}₂; —P(O)₂R^{∘}; —P(O)R^{∘}₂; —OP(O)R^{∘}₂; —OP(O)(OR^{∘})₂; SiR^{∘}₃; —(C₁₋₄ straight or branched alkylene)O-N(R^{∘})₂; or —(C₁₋₄ straight or branched alkylene)C(O)O—N(R^{∘})₂, wherein each R^{∘} may be substituted as defined below and is independently hydrogen, C₁₋₈ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur, or, notwithstanding the definition above, two independent occurrences of R^{∘}, taken together with their intervening atom(s), form a 3-12-membered saturated, partially unsaturated, or aryl mono- or polycyclic ring having 0-4 heteroatoms independently selected from nitrogen, oxygen, or sulfur, which may be substituted as defined below.

Suitable monovalent substituents on R^{∘} (or the ring formed by taking two independent occurrences of R^{∘} together with their intervening atoms), are independently halogen, —(CH₂)₀₋₂R^{●}, -(haloR^{●}), —(CH₂)₀₋₂OH, —(CH₂)₀₋₂OR, —(CH₂)₀₋₂CH(OR^{●})₂; —O(haloR^{●}), —CN, —N₃, —(CH₂)₀₋₂C(O)R^{●}, —(CH₂)₀₋₂C(O)OH, —(CH₂)₀₋₂C(O)OR^{●}, —(CH₂)₀₋₄C(O)N(R^{∘})₂; —(CH₂)₀₋₂SR, —(CH₂)₀₋₂SH, —(CH₂)₀₋₂NH₂, —(CH₂)₀₋₂NHR^{●}, —(CH₂)₀₋₂NR^{●}₂, —NO₂, —SiR^{●}₃, —OSiR^{●}₃, —C(O)SR^{●}, —(C₁₋₄ straight or branched alkylene)C(O)OR^{●}, or —SSR^{●} wherein each R^{●} is unsubstituted or where preceded by “halo” is substituted only with one or more halogens, and is independently selected from C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur. Suitable divalent substituents on a saturated carbon atom of R^{∘} include ═O and ═S.

Suitable divalent substituents on a saturated carbon atom of an “optionally substituted” group include the following: ═O, ═S, ═NNR*₂, ═NNHC(O)R*, ═NNHC(O)OR*, ═NNHS(O)₂R*, ═NR*, ═NOR*, —O(C(R*₂))₂₋₃O—, or —S(C(R*₂))₂₋₃S—, wherein each independent occurrence of R* is selected from hydrogen, C₁₋₄ aliphatic which may be substituted as defined below, or an unsubstituted 5-6-membered saturated, partially unsaturated, or aryl ring having 0-4 heteroatoms independently selected from nitrogen, oxygen, or sulfur. Suitable divalent substituents that are bound to vicinal substitutable carbons of an “optionally substituted” group include: —O(CR*₂)₂₋₃O—, wherein each independent occurrence of R* is selected from hydrogen, C₁₋₆ aliphatic which may be substituted as defined below, or an unsubstituted 5-6-membered saturated, partially unsaturated, or aryl ring having 0-4 heteroatoms independently selected from nitrogen, oxygen, or sulfur.

Suitable substituents on the aliphatic group of R* include halogen, —R^{●}, -(haloR^{●}), —OH, —OR^{●}, —O(haloR^{●}), —CN, —C(O)OH, —C(O)OR^{●}, —NH₂, —NHR^{●}, —NR^{●}₂, or —NO₂, wherein each R^{●} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

Suitable substituents on a substitutable nitrogen of an “optionally substituted” group include —R^{†}, —NR^{†}₂, —C(O)R^{†}, —C(O)OR^{†}, —C(O)C(O)R^{†}, —C(O)CH₂C(O)R^{†}, —S(O)₂R^{†}, —S(O)₂NR^{†}₂, —C(S)NR^{†}₂, —C(NH)NR^{†}₂, or —N(R^{†})S(O)₂R^{†}; wherein each Rt is independently hydrogen, C₁₋₆ aliphatic which may be substituted as defined below, unsubstituted —OPh, or an unsubstituted 5-6-membered saturated, partially unsaturated, or aryl ring having 0-4 heteroatoms independently selected from nitrogen, oxygen, or sulfur, or, notwithstanding the definition above, two independent occurrences of Rf, taken together with their intervening atom(s) form an unsubstituted 3-12-membered saturated, partially unsaturated, or aryl mono-or bicyclic ring having 0-4 heteroatoms independently selected from nitrogen, oxygen, or sulfur.

Suitable substituents on the aliphatic group of Rt are independently halogen, —R^{●}, -(haloR^{●}), —OH, —OR^{●}, —O(haloR^{●}), —CN, —C(O)OH, —C(O)OR^{●}, —NH₂, —NHR^{●}, —NR^{●}₂, or —NO₂, wherein each R^{●} is unsubstituted or where preceded by “halo” is substituted only with one or more halogens, and is independently C₁₋₄ aliphatic, —CH₂Ph, —O(CH₂)₀₋₁Ph, or a 5-6-membered saturated, partially unsaturated, or aryl ring having 0-4 heteroatoms independently selected from nitrogen, oxygen, or sulfur.

As used herein, the term “substantially” refers to the qualitative condition of exhibiting total or near-total extent or degree of a characteristic or property of interest.

The convention of naming ascarosides by a several-letter prefix followed by a pound sign (#) and a number is sometimes used (for example ascr #18). This convention is used in the scientific literature and the skilled artisan will understand that each such name is associated with a specific chemical structure of known composition and will readily apprehend the structure of the molecule referred to using this naming convention. Unless otherwise indicated, all compound identifiers of this format used herein conform to the definitions described in the C. elegans Small Molecule Identifier Database (SMID-DB) maintained at http://www.smid-db.org.

The term “pathogen” refers to any bacterium, fungus, oomecyte, virus, nematode (e.g., cyst or root knot nematode) or insect with pathogenic effects on a plant.

### DETAILED DESCRIPTION OF THE INVENTION

Compositions and methods for the use of ascarosides are provided. The disclosure is directed to treatment of plants with one or more ascarosides and one or more additional active agents (e.g., fungicides or other antimicrobial agents). In certain embodiments, the disclosure provides combinations of one or more naturally occurring ascarosides (which have a biological origin and a mode of action that classifies them as biological products (e.g., biofungicide)) with one or more synthetic chemical fungicides. It is known that co-application of biological products with chemical fungicides often results in lowered activity of the biological product, or creates other challenges related to physical or chemical incompatibility of the biological and the chemical formulations or requirements for different application timing or methods. In certain embodiments, application of the provided biological/synthetic combinations are surprisingly stable and demonstrate additive or synergistic effects that are unexpected, given the very different modes of action and application rates. Certain fungicides suitable for inclusion in the provided compositions and methods include, but are not limited to chemical fungicides such as triazole fungicides, strobilurin fungicides, or SDHI fungicides. According to the present disclosure, treatment can be via the separate application of the one or more ascarosides and the one or more additional active agents or can be via a composition comprising both the one or more ascarosides and the one or more additional active agents. In some embodiments, the one or more ascarosides and the one or more additional active agents exhibit synergy.

### Ascarosides

Ascarosides are derivatives of the sugar ascarylose—a di-deoxy sugar lacking hydroxyl groups at its 3- and 6-positions. Ascarosides have the general structure shown in Formula I:

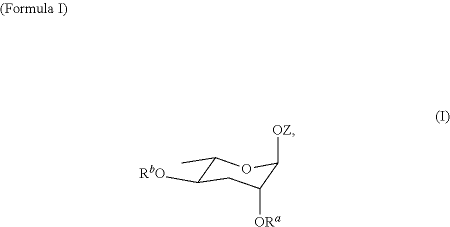

wherein:
Z is an optionally substituted C₂₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g., -a moiety —C(O)OR^{c}), a C₂₋₂₀ carbamate (e.g., -a moiety —C(O)N(R^{c})₂), a C₂₋₂₀ thioester (e.g., a moiety —C(S)R^{c}), a C₂₋₂₀ thiocarbonate (e.g., a moiety —C(S)OR^{c}), a C₂₋₂₀ dithiocarbonate (e.g., a moiety —C(S)SR^{c}), a C₁₋₂₀ thiocarbamate (e.g., a moiety —C(S)N(R^{c})₂), a sugar moiety, a peptide, a polymer chain, or a linkage via a bond or a carbon-containing linker moiety to another ascaroside molecule, where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

In certain embodiments, Z is:
(i) —CH(CH₃)—R¹, where R¹ is an optionally substituted C₁₋₄₀ aliphatic group;
(ii) —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iii) —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(iv) —CH(CH₃)—(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(v) —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vi) —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(vii) —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
(viii) —(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; or
(ix) —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule.

In certain embodiments, Z is:
(x) —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xi) —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁-₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xii) —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁-₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiii) —CH(CH₃)—(CH₂)˜-C(O)—CH—CON(R³)₂, where n is an integer from 1 to 40, and each R³ is independently —H, an optionally substituted C₁₋₂₀ aliphatic group, an optionally substituted C₁-₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xiv) —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xv) —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
(xvi) —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁-₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; or
(xvii) —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

In certain embodiments, R^{a} is —H.

In certain embodiments R^{b} is —H.

In certain embodiments, R^{a} and R^{b} are the same. In certain embodiments R^{a} and R^{b} are both —H.

In certain embodiments, R^{a} and R^{b} are different. In certain embodiments, R^{a} is —H, and R^{b} is other than —H. In certain embodiments, R^{a} is other than —H and R^{b} is —H. In certain embodiments, R^{a} is —H and R^{b}is p-hydroxybenzoate. In certain embodiments, R^{a} is —H and R^{b} is indole-3-carboxylate. In certain embodiments, R^{a} is —H and R^{b} is (E)-2-methyl-2-butenoate. In certain embodiments, R^{a} is —H and R^{b} is picolinate. In certain embodiments, R^{a} is —H and R^{b} is nicotinate. In certain embodiments, R^{a} is —H and R^{b}is (R)-2-hydroxy-2-(4-hydroxyphenyl)ethyl)amino)-4-oxobutanoate. In certain embodiments, R^{a} is —H and R^{b} is 4-((4-hydroxyphenethyl)amino)-4-oxobutanoate.

In certain embodiments R^{a} and R^{b} are both —H, and Z is selected from the formulae defined in (i) to (xvii) above. In certain embodiments R^{a} and R^{b} are both —H, and Z conforms to formula (i) above. In certain embodiments R^{a} and R^{b} are both —H, and Z conforms to formula (ii) above. In certain embodiments R^{a} and R^{b} are both —H, and Z conforms to formula (iii) above. In certain embodiments R^{a} and R^{b} are both —H, and Z conforms to formula (iv) above. In certain embodiments R^{a} and R^{b} are both —H, and Z conforms to formula (v) above. In certain embodiments R^{a} and R^{b} are both —H, and Z conforms to formula (vi) above. In certain embodiments R^{a} and R^{b} are both —H, and Z conforms to formula (vii) above. In certain embodiments R^{a} and R^{b} are both —H, and Z conforms to formula (viii) above. In certain embodiments R^{a} and R^{b} are both —H, and Z conforms to formula (ix) above. In certain embodiments R^{a} and R^{b} are both —H, and Z conforms to formula (x) above. In certain embodiments R^{a} and R^{b} are both —H, and Z conforms to formula (xi) above. In certain embodiments R^{a} and R^{b} are both —H, and Z conforms to formula (xii) above. In certain embodiments R^{a} and R^{b} are both —H, and Z conforms to formula (xiii) above. In certain embodiments R^{a} and R^{b} are both —H, and Z conforms to formula (xiv) above. In certain embodiments R^{a} and R^{b} are both —H, and Z conforms to formula (xv) above. In certain embodiments R^{a} and R^{b} are both —H, and Z conforms to formula (xvi) above. In certain embodiments R^{a} and R^{b} are both —H, and Z conforms to formula (xvii) above

In certain embodiments, R² is —H. In certain embodiments, R² is a metal cation. In certain embodiments, R² is an organic cation (e.g., a nitrogen- or phosphorous-centered cationic group). In certain embodiments, R² is an optionally substituted C₁₋₂₀ aliphatic group. In certain embodiments, R² is an optionally substituted C₁.n aliphatic group. In certain embodiments, R² is an optionally substituted C₁.s aliphatic group. In certain embodiments, R² is an optionally substituted C₁₋₆ aliphatic group. In certain embodiments, R² is selected from methyl, ethyl, n-propyl, i-propyl, n-butyl, sec-butyl, and t-butyl. In certain embodiments, R² is an optionally substituted aromatic group. In certain embodiments, R² is a glycoside. In certain embodiments, R² comprises an amino acid. In certain embodiments, R² comprises a peptide. In certain embodiments, R² comprises a nucleotide.

In certain embodiments, at least one R³ is —H. In certain embodiments, both R³ groups arc —H. In certain embodiments, at least one R³ is an optionally substituted C₁₋₂₀ aliphatic group. In certain embodiments, both R³ groups are an optionally substituted C₁₋₂₀ aliphatic group which may be the same or different. In certain embodiments, at least one R³ is an optionally substituted C₁₋₂ aliphatic group. In certain embodiments, at least one R³ is an optionally substituted C₁₋₈ aliphatic group. In certain embodiments, at least one R³ is an optionally substituted C₁₋₆ aliphatic group. In certain embodiments, at least one R³ is selected from methyl, ethyl, n-propyl, i-propyl, n-butyl, sec-butyl, and t-butyl. In certain embodiments, at least one R³ is —CH₂CH₂OH. In certain embodiments, at least one R³ is —CH₂CH₂OR², where R² is as defined in the genera and subgenera herein. In certain embodiments, at least one R³ is an optionally substituted aromatic group. In certain embodiments, at least one R³ comprises a glycoside. In certain embodiments, at least one R³ comprises an amino acid. In certain embodiments, at least one R³ at least one R³ comprises a peptide. In certain embodiments, at least one R³ comprises a nucleotide.

In certain embodiments, an ascaroside is selected from the group consisting of:

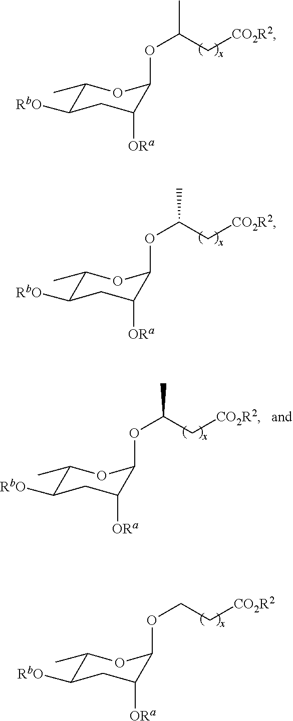

where x is an integer from 1 to 22, and each of R^{a}, R^{b}, and R² is as defined above and in the genera and subgenera herein.

In certain embodiments, an ascaroside is selected from the group consisting of:

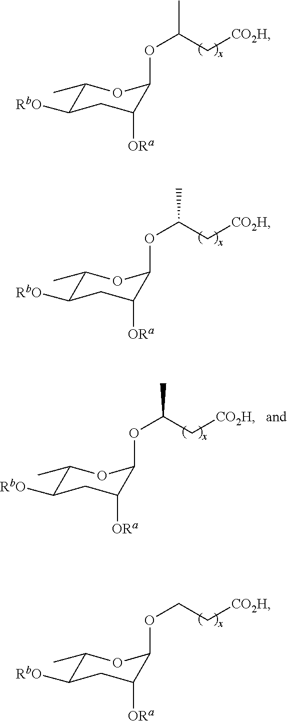

where each of x, R^{a}, and R^{b}, is as defined above and in the genera and subgenera herein.

In certain embodiments, an ascaroside is selected from the group consisting of:

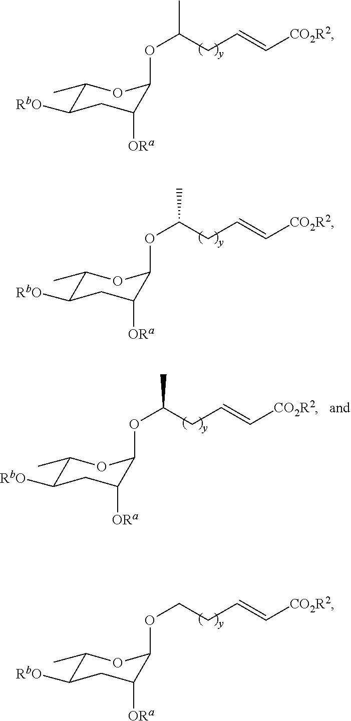

where y is an integer from 1 to 20, and each of R^{a}, R^{b}, and R² is as defined above and in the genera and subgenera herein.

In certain embodiments, an ascaroside is selected from the group consisting of:

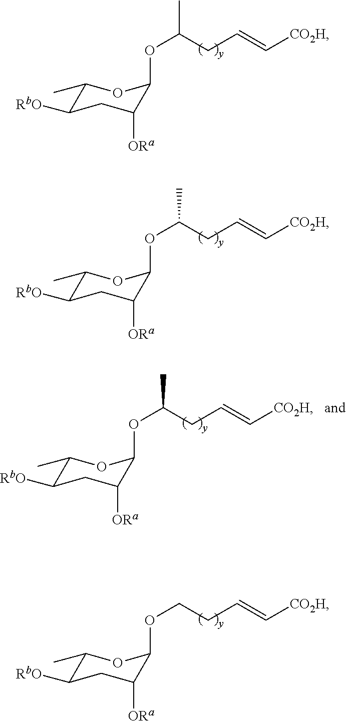

where each of y, R^{a}, and R^{b}, is as defined above and in the genera and subgenera herein.

In certain embodiments, an ascaroside is selected from the group consisting of:

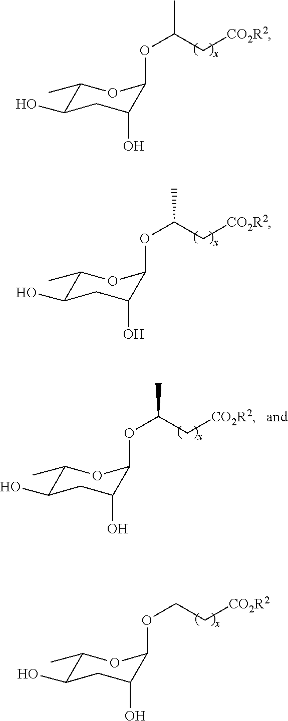

where x is an integer from 1 to 22, and R² is as defined above and in the genera and subgenera herein.

In certain embodiments, an ascaroside is selected from the group consisting of:

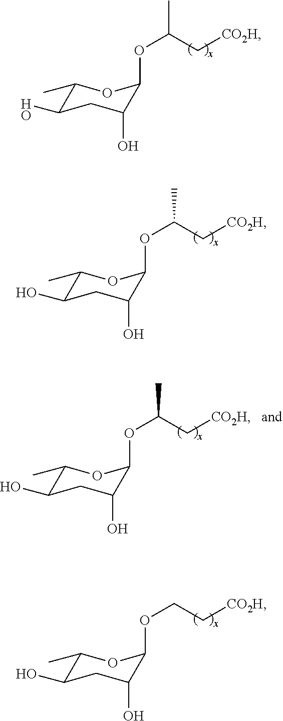

where x is as defined above and in the genera and subgenera herein.

In certain embodiments, an ascaroside is selected from the group consisting of:

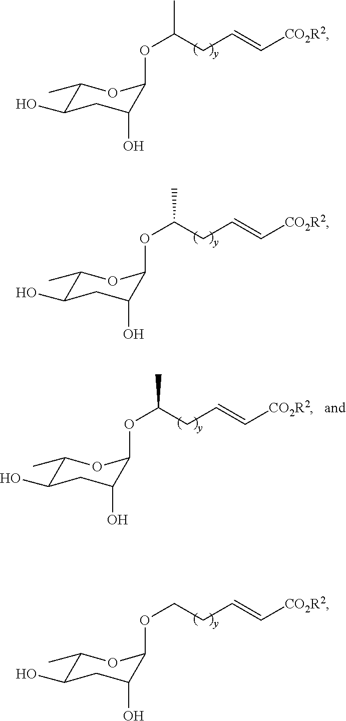

where y is an integer from 1 to 20, and R² is as defined above and in the genera and subgenera herein.

In certain embodiments, an ascaroside is selected from the group consisting of:

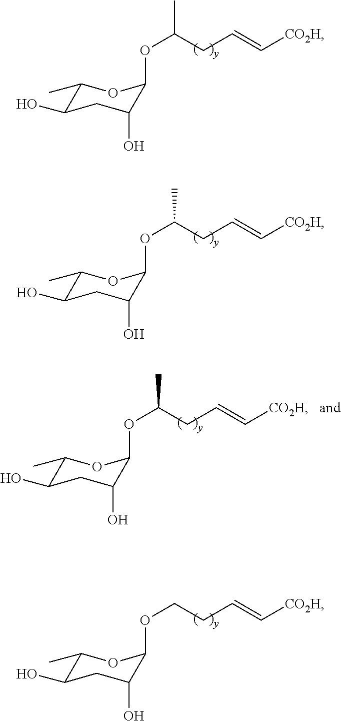

where y is as defined above and in the genera and subgenera herein.

In certain embodiments, an ascaroside is selected from the group consisting of:

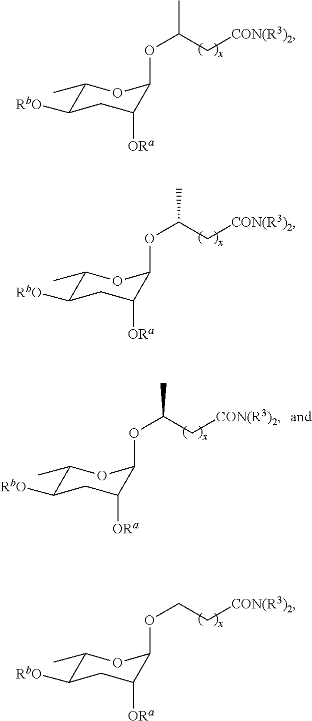

where x is an integer from 1 to 22, and each of R^{a}, R^{b}, and R³ is as defined above and in the genera and subgenera herein.

In certain embodiments, an ascaroside is selected from the group consisting of:

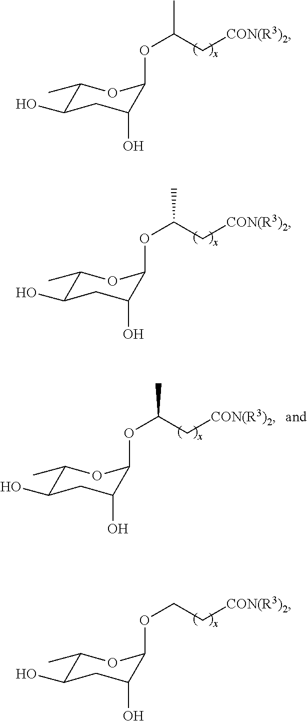

where each of x and R³ is as defined above and in the genera and subgenera herein.

In certain embodiments, an ascaroside is selected from the group consisting of:

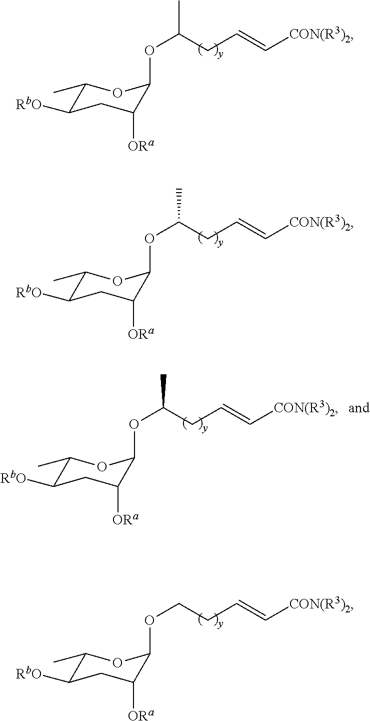

where y is an integer from 1 to 20, and each of R^{a}, R^{b}, and R² is as defined above and in the genera and subgenera herein.

In certain embodiments, an ascaroside is selected from the group consisting of:

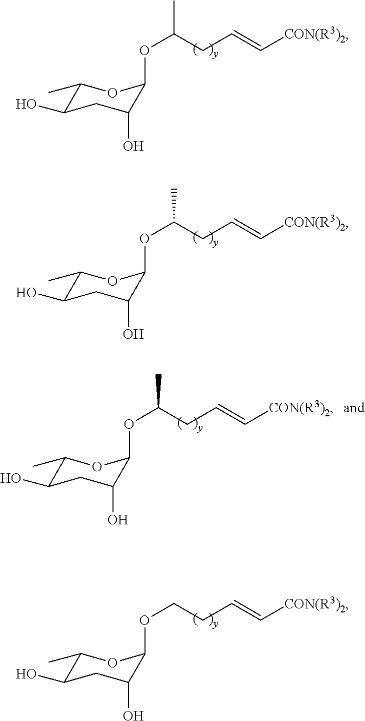

where each of y and R³ is as defined above and in the genera and subgenera herein.

In an embodiment, ascarosides useful in the context of the present disclosure have the general structure (I). where Z is —CH(CH₃)—(CH₂)ₙ—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide, and can be used for inhibiting human pathogenic bacterial growth in or on a plant.

In an embodiment, ascarosides useful in the context of the present disclosure have the general structure (I) where Z is —CH(CH₃)—(CH₂),—CH═CH—CO₂R², where n is an integer from 1 to 40, and R² is —H, a metal cation, an optionally substituted C₁₋₂₀ aliphatic group, an optionally substituted aromatic group, a glycoside, an amino acid, a peptide, or a nucleotide.

Specific ascarosides that are useful in the context of the present disclosure include, but are not limited to, ascr #7 and ascr #18.

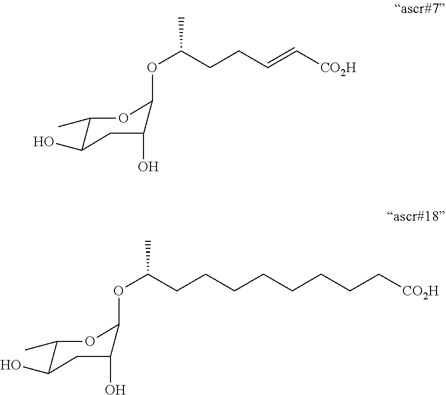 [SMILES: CC1OC(O[C@H](C)CC/C=C/C(=O)O)C(O)CC1O ; CC1OC(O[C@H](C)CCCCCCCCC(=O)O)C(O)CC1O]

In certain embodiments, an ascaroside used in the provided methods and compositions is selected from the group consisting of: ascr #9, ascr #12, ascr #14, ascr #1, ascr #10, ascr #16, ascr #18, ascr #20, ascr #22, ascr #24, ascr #26, ascr #28, ascr #30, ascr #32, ascr #34, and ascr #36. In certain embodiments, an ascaroside used in the provided methods is selected from the group consisting of: ascr #10, ascr #16, ascr #18, ascr #20, ascr #22, and ascr #24. In certain embodiments, an ascaroside used in the provided methods is selected from the group consisting of: ascr #9. ascr #14, ascr #10, and ascr #18.

In certain embodiments, an ascaroside used in the provided methods and compositions is selected from the group consisting of: ascr #5, oscr #9, oscr #12, oscr #1, oscr #14, oscr #10, oscr #16, oscr #18, oscr #20, oscr #22, oscr #24, oscr #26. oscr #28, oscr #30, oscr #32, oscr #34, and oscr #36. In certain embodiments, an ascaroside used in the provided methods is selected from the group consisting of: oscr #10, oscr #16, oscr #18, oscr #20, and oscr #22. In certain embodiments, an ascaroside used in the provided methods is selected from the group consisting of: bhas #5, oscr #9, oscr #12, oscr #1, oscr #14, oscr #10, oscr #16, oscr #18, oscr #20, oscr #22, oscr #24, oscr #26. oscr #28, oscr #30, oscr #32, oscr #34, and oscr #36. In certain embodiments, an ascaroside used in the provided methods is selected from the group consisting of: oscr #10, oscr #16, oscr #18, oscr #20, and oscr #22.

In certain embodiments, an ascaroside used in the provided methods and compositions is selected from the group consisting of: bhas #9, bhas #10, bhas #16, bhas #18, bhas #22, bhas #24, bhas #26, bhas #28, bhas #30, bhas #32, bhas #34, bhas #36, bhas #38, bhas #40, and bhas #42.

In certain embodiments, an ascaroside used in the provided methods and compositions is selected from the group consisting of: bhos #10, bhos #16, bhos #18, bhos #22, bhos #24, bhos #26, bhos #28. bhos #30, bhos #32, bhos #34, bhos #36, bhos #38, bhos #40, and bhos #42.

In certain embodiments, an ascaroside used in the provided methods and compositions is selected from the group consisting of: ascr #18, oscr #16, oscr #17, oscr #15, bhas #18, bhos #16, glas #18, dhas #18, ibha #18, ibho #16, icas #18, icos #15, icos #16, and any combination of two or more of these.

In some embodiments, an ascaroside used in the provided methods and compositions is an Ascaroside salt as disclosed in international application number PCT/US2023/21731, filed May 10, 2023 or an Ascaroside modified to provide for extended release of the active ingredient as disclosed in international application number PCT/US2023/20472, filed Apr. 28, 2023, both of which are incorporated by reference herein in their entireties.

Ascarosides can be obtained from natural sources (e.g., nematodes) or they may be prepared synthetically. Ascarosides can be prepared synthetically, for example, by converting 1-O-substituted rhamnose to 1-O-substituted ascarylose. An exemplary method of preparing ascarosides includes: providing as a feedstock a 1-O-substituted rhamnose; forming a mono-sulfonate ester at the 3-OH group of the feedstock; and treating the mono-sulfonate ester with a hydride source to form a 1-O-substituted ascarylose. In certain embodiments, forming the mono-sulfonate ester is conducted on a substrate without hydroxyl protecting groups at the 2- or 4-position of the rhamnose feedstock. In certain embodiments, such methods comprise contacting the feedstock with a sulfonating agent (i.e., a sulfonyl halide, sulfonic anhydride or similar reagent) in the presence of a Lewis acid. Specific details regarding the synthesis of 1-O-substituted ascarylose can be found in PCT Application Publication No. WO/2022/024067, which is incorporated herein by reference.

### Additional Active Agent(s)

The one or more additional active agents in various methods and compositions as provided herein encompass all compounds understood to exhibit beneficial activity against one or more pathogens. Such active agents are generally antimicrobial agents and include, but are not limited to, antibacterial agents (also referred to as bactericides), antifungal agents (also referred to as fungicides), insecticidal agents (also referred to as insecticides), and anthelmintic agents (also referred to as nematicides).

Antimicrobial agents useful in the disclosed methods and formulations are not particularly limited. Suitable active agents may be preventative or curative, may have single-site or multi-site activity, may be narrow-spectrum or broad-spectrum in effect, and may be organic or inorganic. They may be chemical or biological. In some embodiments, the active agents are natural, with active ingredients including, but not limited to, sulfur, lime-sulfur, copper (e.g., in the form of copper sulfate), oils (e.g., horticultural oil, neem oil, rosemary oil, and jojoba oil), bicarbonates (e.g., sodium bicarbonate, potassium bicarbonate, and ammonium bicarbonate), and combinations thereof.

Certain broad chemical classes of suitable fungicidal compounds useful in certain embodiments as disclosed herein include, but are not limited to, substituted benzenes, thiocarbamates, dithiocarbamates, thio phthalimide copper compounds, nitriles/benzonitriles/chloronitriles, benzimidazoles, dicarboximides, carboxamides/anilides. strobilurins, phenylpyrroles, aromatic hydrocarbons, polyoxins, pyridinamines, phenylamides. cyanoimidazoles, phosphonates, and combinations thereof. Fungicides useful in various formulations and methods as described herein can also be defined by mode of action, e.g., as follows: mitosis disrupters (e.g., thiophanates such as thiophanate-methyl); cell membrane disrupters (e.g., triazoles, such as cyproconazole, difenoconazole, flutriafol, mefentrifluconazole, metconazole, propiconazole, tebuconazole, and tetraconazole; and triazolinthiones, such as prothioconazole); respiration inhibitors (e.g., succinate dehydrogenase inhibitors/carboxamides, such as pyridine carboxamides (e.g., boscalid), pyridinyl-ethylbenzamides (e.g., fluopyram), and pyrazole-4-carboxamides (e.g., benzovindiflupyr, bixafen, fluxapyroxad, penthiopyrad, pydiflumetofen) and quinone outside inhibitors/strobilurins, such as methoxy acrylates (e.g., azoxystrobin and picoxystrobin), dihydro-dioxazines (e.g., fluoxastrobin), methoxy-carbamates (e.g., pyraclostrobin), and oximino-acetates (e.g., trifluoxystrobin)); oxidative phosphorylation uncouplers (e.g., 2,6-dinitroanilines, such as fluazinam); fungicides of unknown activity (e.g., phosphonates, such as phosphorous acid and salts); and fungicides with multi-site contact activity (e.g., inorganic fungicides, such as copper salts and chloronitriles/phthalonitriles, such as Chlorothalonil).

Suitable specific additional active agents include, but are not limited to, acibenzolar, acibenzoloar-S-methyl, Agrobacterium radiobacter, aldicarb, aliphatic petroleum distillate, allyl isothiocyanate, aluminum tris, ametoctradin, 2-aminobutane, Ampelomyces quisqualis, anilazine, Aureobasidium pullulans (e.g., strains DSM 14940 and 14941), azadirachtin, azoxystrobin, Bacillus amyloliquefaciens (e.g., strain D747 or F727), Bacillus firmus (e.g., Strain I-1582), Bacillus mycoides (e.g., isolate J), Bacillus pumilus (e.g., strain QST 2808), Bacillus subtilis (e.g., strain IAB/BS03, strain QST 713, strain BG03, or strain MBI 600), basic cupric carbonate, benomyl, benzovindiflupyr, bifenazate, bixafen, BLAD, borax, boric acid, boscalid, Burkholderia cepacia, Candida oleophila, capric and caprylic acid, captafol, captan, carbendazim, carbofuran, carbon disulfide, carboxin, chitin, chlorfenapyr, chlorine dioxide, chloroneb, chloropicrin, chlorothalonil, cinnamaldehyde, ciproconazole, clove oil, Coniothyrium minitans (e.g., Strain CON/M/91-08), copper, copper ammonium complex (e.g., copper ammonium carbonate, tannate complex of picro cupric ammonium formate), copper diammonia diacetate complex, copper hydroxide, copper octanoate, copper oxide, copper oxychloride, copper sulfate, cresol, cyazofamid, cyclohexane polymer, cycloheximide, cyflufenamid, cymoxanil, cyproconazole, cyprodinil, dazomet, debacarb, dichlone, dichloran, dichloropropene, dicofol, difenoconazole, difenoxazole, difolatan, dimethomorph, demeton, dimethyl disulfide, dinocap, dodemorph acetate, dodine, epoxiconazole, ethaboxam, ethoprop, ethoxyquin, ethylene dibromide, ethaboxam, etridiazole, famoxadone, fenamidone, fenaminosulf, fenamiphos, fenarimol, fenazaquin, fenbuconazole, fenhexamid, fenpyrazamine, fensulfothion, ferbam, fluazinam, fludioxonil, fluensulfone, fluopicolide, fluopyram, fluoxastrobin, fluquinconazole, flusilazole, flutianil, flutolanil, flutriafol, fluxapyroxad, folpet, formaldehyde, fosetyl-Al, gamma aminobutyric acid, gibberellic acid, Gliocladium catenalatum (e.g., Strain J1446), Gliocladium virens, harpin, hexachlorobenzene, horticultural mineral oil, hydrated lime, hymexazole, imazalil, iodomethane, ipconazole, iprodione, isofetamid, jojoba oil, kasugamyacin, kresoxim-methyl, L-glutamic acid, laminarin, lime sulfur, mandestrobin, mandipropamid, maneb, mancozeb, mefenoxam, mefentrifluconazole, metalaxyl, metam sodium, metconazole, methyl bromide, methylcyclopropene, methyl isothiocyanate, metrafenone, methyl bromide, methylcyclopropene, metiram, myclobutanil, Myrothecium verrucaria (e.g., strain AARC-0255), neem oil, oxadixyl, oxamyl, oxthioquinox, oxathiapiprolin, oxycarboxin, oxytetracycline, oxythioquinox, Paecilomyces lilacinus (e.g., Strain 251), Pantoea agglomerans (e.g., strain E325), parinol, pentachloronitrobenzene (PCNB), penthiopyrad, peroxide, peroxyacetic acid, peroxyhydrate, petroleum oil, phenylmercury acetate, phosphites, phosphorous acid, picoxystrobin, polyalkylene modified heptamethyltrisiloxane, polyoxin D, polyoxin D zinc salt, potassium bicarbonate, potassium phosphite, potassium silicate, prohexadione calcium, propamocarb, propiconazole, prothioconazole, Pseudomonas aureofaciens, Pseudomonas chlororaphis (e.g., Strain AFS009), Pseudomonas fluorescens, Pseudomonas syringae, pydiflumetofen, pyraclostrobin, pyrimethanil, pyriofenone, quaternary ammonium, quinoxyfen, Reynoutria sachalinensis. rosemary oil, saponins, sedaxane, sodium hypochlorite, spiroxamine, Streptomyces griseoviridis (e.g., strain 61), streptomycin, sulfur, Swinglea glutinosa, tebuconazole, tetrathiocarbonate, thiabendazole, thiamethoxam, thiophanate, thiophanate-methyl, thiram, thyme oil, triadimefon, triadimenol, Trichoderma asperellum (e.g., strain T34), Trichoderma gamsii, Trichoderma harzianum, trifloxystrobin, triflumazole, triforine, triphenyltin hydroxide, triticonazole, urea, Urocladium oudemansii (e.g., U3 strain), vinclozolin, wanilazine, xylenol, zineb, ziram, zoxamid, and combinations thereof.

In some embodiments, the one or more ascarosides are combined with one or more commercially available antimicrobial agents, e.g., one or more fungicides. In some embodiments, such commercially available antimicrobial agents are fungicidal mixtures. Commercially available antimicrobial agents are known in the art and include, but are not limited to, ABOUND® (Syngenta) comprising Azoxystrobin; ABSOLUTE® (Bayer Crop Science), comprising tebuconazole and trifloxystrobin; ACADEMY® (Syngenta) comprising difenoconazole and fludioxonil; ACTIGARD® (Syngenta) comprising acibenzolar-S-methyl; ADAMENT® (Bayer Crop Science), comprising tebuconazole and trifloxystrobin; ALIETTE® (Bayer Crop Science), comprising aluminum tris(O-ethyl phosphonate); ALTO® (Syngenta) comprising cyproconazolc; ALUMNI® (Syngenta) comprising thiabendazole; AMISTAR® (Syngenta) comprising azoxystrobin and difenoconazole; APROACH® (DuPont™) comprising picoxystrobin and cyproconazole; APROVIA® (Syngenta) comprising benzovindiflupyr (alone or with propiconazole or difenoconazole); ARCHIVE (Syngenta) comprising fludioxonil and azoxystrobin; CABRIO®, comprising pyraclostrobin; CANNONBALL® (Syngenta) comprising fludioxonil; CARAMBA® (BASF), comprising metconazole; CHAIRMAN® (Syngenta) comprising fludioxonil and propiconazole; CHAMPION® (Nufarm), comprising copper hydroxide and metallic copper equivalent; DELARO® (Bayer Crop Science), comprising trifloxystrobin and prothioconazole; ELATUS® (Syngenta) comprising Azoxystrobin and benzovindiflupyr; F500® (BASF), comprising a strobilurin; FLINTR (Bayer Crop Science), comprising trifloxystrobin; FONTELIS® (Corteva) comprising penthiopyrad; GRADUATE® (Syngenta) comprising fludioxonil (alone or with azoxystrobin); INITUM® (BASF), INSPIRE® (Syngenta) comprising difenoconazole (alone or with cyprodinil or propiconazole); LUNA® (Bayer Crop Science), comprising fluopyram and pyrimethanil; MENTOR® (Syngenta) comprising Propiconazole; MERTECT® (Syngenta) comprising thiabendazole; MINUET® (Bayer Crop Science) comprising Bacillus subtilis strain QST 713; MIRAVIS® (Syngenta) comprising pydiflunetofen (alone or in combination with difenoconazole or propiconazole or fludioxonil or azoxystrobin and propiconazole), OMETGA® (Syngenta) comprising fluazinam; ORONDIS® (Syngenta) comprising oxathiapiprolin (alone or in combination with mefenoxam or chlorothalonil or mandipropamid); PREVICUR® (Bayer Crop Science) comprising propamocarb hydrochloride; PRISTINE®, comprising pyraclostrobin and boscalid; PROLINE® (Bayer Crop Science) comprising prothioconazole; PROPULSE® (Bayer Crop Science) comprising fluopyram and prothioconazole; PROSARO® (Bayer Crop Science) comprising prothioconazole and tebuconazole; PROVOST® (Bayer Crop Science) comprising prothioconazole and tebuconazole; QUADRIS® (Syngenta) comprising azoxystrobin (alone or in combination with Chlorothalonil, mefenoxam, or difenoconazole); QUILT® (Syngenta) comprising Azoxystrobin and Propiconazole; REGALIA® (Marrone BioInnovations), comprising Reynoutria sachalinensis; REVUS® (Syngenta) comprising mandipropamid (alone or in combination with difenoconazole); RIDOMIL® (Syngenta) comprising mefenoxam (alone or in combination with chlorothalonil, copper OH, or mancozeb) SCALA® (Bayer Crop Science) comprising pyrimethanil and 1,2-propanediol; SCHOLAR® (Syngenta) comprising fludioxonil; SERENADE® (Bayer Crop Science) comprising Bacillus subtilis strain QST 713; STRATEGO® (Bayer Crop Science) comprising Propiconazole and Trifloxystrobin; STADIUM® (Syngenta) comprising azoxystrobin, fludioxonil, and difenoconazole; SWITCH® (Syngenta) comprising cyprodinil and fludioxonil; TANOS® (DuPont™) comprising famoxadone and cymoxanil; TILT® (Syngenta) comprising Propiconazole (alone or in combination with Chlorothalonil); TOP® (Syngenta) comprising difenoconazole; TRIVAPRO® (Syngenta) comprising Propiconazole, Azoxystrobin, and benzovindiflupyr; UNIFORM® (Syngenta) comprising Azoxystrobin and mefenoxam; VANGARD® (Syngenta) comprising cyprodinil; VELUM® (Bayer Crop Science) comprising fluopyram; VIBRANCE® (Syngenta) comprising sedaxane, mefenoxam, and fludioxonil with thiabendazole or azoxystrobin; VYDATE® (DuPont™) comprising oxamyl; and XEMIUM® (BASF) comprising a carboxamide.

Certain, non-limiting active combinations of ascarosides and specific types of additional active agents that find use in various embodiments of the present disclosure are described in more detail below.

### Ascaroside+Triazole Fungicide

In some embodiments, the disclosure provides compositions and methods relating to an ascaroside and a triazole (e.g., prothioconazole, tebuconazole, or a fungicide having the same mode of action as prothioconazole or tebuconazole). In some embodiments, the ascaroside can be used with any triazole fungicide or any fungicide that inhibits the CYP51A1 enzyme. The CYP51A1 enzyme is required to biosynthesize ergosterol, a key component in the cell membrane of fungi. The use of the fungicide with at least one ascaroside enhances the activity of the fungicide such that lesser amounts of the fungicide are needed.

Triazole fungicides include but are not limited to, Myclobutanil, Epoxiconazole, Ipconazole, Metconazole, Uniconazole-P, Uniconazole, Triticonazole, Tricyclazole, Triazbutil, Triadimenol, Triadimefon, Tetraconazole, Tebuconazole, Simeconazole, Quinconazole, Prothioconazole, Propiconazole, Penconazole, Imibenconazole, Hexaconazole, Furconazole, Furconazole-cis, Flutriafol, Flusilazole, Fluquinconazole, Fluotrimazole, Fenbuconazole, Etaconazole, Diniconazole-M, Diniconazole, Difenoconazole, Diclobutrazol, Cyproconazole, Bromuconazole, Bitertanol, Azaconazole, and Amisulbrom. In particular embodiments, the triazole fungicide is prothioconazole or tebuconazole. Mixtures of fungicides are also encompassed, particularly fungicides that are used in combination with prothioconazole, tebuconazole, or other triazoles. Such fungicides used with prothioconazole include, but are not limited to, azoxystrobin, boscalid, tebuconazole, trifloxystrobin, fluopyram, azoxystrobin and benzovindiflupyr, and the like. Such fungicides used with tebuconazole include, but are not limited to, azoxystrobin, boscalid, prothioconazole, trifloxystrobin, fluopyram, azoxystrobin and benzovindiflupyr, and the like.

Prothioconazole (IUPAC: (RS)-2-[2-(1-chlorocyclopropyl)-3-(2-chlorophenyl)-2-hydroxypropyl|-2,4-dihydro-1,2,4-triazole-3-thione) is a synthetic chemical produced primarily for its fungicidal properties. Prothioconazole is a systemic, broad-spectrum fungicide in the triazolinthioine chemical class. It is a member of the class of compounds triazoles and possesses a unique toxophore in this class of fungicides. Its effective fungicidal properties can be attributed to its ability to inhibit CYP51A1. This enzyme is required to biosynthesize ergosterol, a key component in the cell membrane of fungi. Prothioconazole is a fungicide produced for the control of diseases caused by ascomycetes, basidiomycetes, and deuteromycetes. Prothioconazole is generally applied alone or as a tank mix with other agents, such as fungicides, insecticides, herbicides, or other crop agents. While any source of prothioconazole can be used, it is sold under various tradenames including Co-Op Pivot. Nufarm Propiconazole, Princeton, Fitness, Pivot 418EC, Quilt, Topnotch, Trivapro, Proline, Cotegra, Prosaro 250EC, Prosaro XTR, Delaro 325SC, Propulse, and Timor 240EC.

Prothioconazole is typically formulated as a 4 lb/gal suspension concentrate (equivalent to a flowable concentrate; FlC) formulation (Proline®480 SC Fungicide, 41% active ingredient). The product may be applied as broadcast post emergence foliar or soil sprays (application to soil for peanuts) using ground or aerial equipment at 0.088-0.178 lb ai/A/application (0.100-0.200 kg ai/ha/application). The proposed maximum seasonal rates range 0.285-0.713 lb ai/A (0.320-0.800 kg ai/ha), and the proposed retreatment intervals are 5-21 days. Using prothioconazole with at least one ascaroside according to the present disclosure increases the activity of the fungicide and makes it more efficient in reducing the severity of the disease and for its control. Thus, lower concentrations or rates of prothioconazole are needed.

Tebuconazole (IUPAC: 1-(4-chlorophenyl)-4,4-dimethyl-3-(1,2,4-triazol-1-ylmethyl)pentan-3-ol) is a systemic fungicide and delivers both curative and preventative control of diseased plants. Tebuconazole is used in a number of different popular fungicide products to control fungi, bacteria, and viruses affecting plants. Tebuconazole is a fungicide that is known as a DMI (demethylation inhibiting fungicide) works by affecting the cell walls of fungi by suppressing spore germination and fungus growth. It also interferes with the production of ergosterol, a molecule essential to the formation of fungus. As a result, the formation of fungus is slowed and eventually stopped. Because of this unique mode of action Tebuconazole is fungistatic or growth-inhibiting rather than fungicidal or fungus killing. Tebuconazole is a flexible fungicide that can be used for both curative and preventative fungus control. It works systemically, absorbing into the target plant to protect it against diseases, prevent further spread or can eliminate the disease entirely depending on the severity level. Some of the common fungal and disease problems tebuconazole is known to treat are rust fungus, sheath blight, leaf spot, and anthracnose. Tebuconazole may also be used on turf and ornamental plants to control various fungal diseases including but not limited to brown patch, gray leaf spot, and powdery mildew.

Tebuconazole may be applied at rates of 4-10 fl. oz. per acre. Spray volume may range from about 5 up to 300 gallons of finished spray per acre depending upon equipment, plant species and plant growth stage at time of application. However, if too much triazole active ingredient is absorbed into the plant, it can cause phytotoxicity, poisoning the plant. Some plants are sensitive to the triazole active ingredient. Thus, the use of tebuconazole with an ascaroside as provided according to the present disclosure can reduce or prevent phytotoxicity as less tebuconazole is needed to achieve comparable results.

In certain embodiments, the disclosure provides blends of a triazole fungicide and an ascaroside where a weight ratio of a triazole fungicide to ascaroside is greater than 1000:1. In certain embodiments, the disclosure provides blends of a triazole fungicide and an ascaroside where a weight ratio of a triazole fungicide to ascaroside is greater than 1500:1, greater than 2000:1, greater than 3000:1, greater than 5000:1, greater than 7500:1, or greater than 10,000:1.

In certain embodiments, the disclosure provides blends of a triazole fungicide and an ascaroside characterized in that the blended product is labeled for application to crops at a rate that is lower than the label rate of the triazole fungicide alone. In certain embodiments, the blend is characterized in that the lowest label application rate delivers less than 4 oz of a triazole fungicide per acre, less than 3 oz. less than 2.5 oz, less than 2 oz, or less than 1 oz of a triazole fungicide per acre. In certain embodiments, such blends are characterized in that they are more efficacious at reducing fungal disease on the crops to which they are applied than a triazole fungicide applied alone at full label rate (e.g., 4-10 oz per acre).

In certain embodiments, the disclosure provides blends of tebuconazole and an ascaroside where a weight ratio of tebuconazole to ascaroside is greater than 1000:1. In certain embodiments, the disclosure provides blends of tebuconazole and an ascaroside where a weight ratio of tebuconazole to ascaroside is greater than 1500:1, greater than 2000:1, greater than 3000:1, greater than 5000:1. greater than 7500:1, or greater than 10,000:1.

In certain embodiments, the disclosure provides blends of tebuconazole and an ascaroside characterized in that the blended product is labeled for application to crops at a rate that is lower than the label rate of tebuconazole alone. In certain embodiments, the blend is characterized in that the lowest label application rate delivers less than 4 oz of tebuconazole per acre, less than 3 oz. less than 2.5 oz, less than 2 oz, or less than 1 oz of tebuconazole per acre. In certain embodiments, such blends are characterized in that they are more efficacious at reducing fungal disease on the crops to which they are applied than tebuconazole applied alone at full label rate (e.g., 4-10 oz per acre).

In certain embodiments, the disclosure provides blends of prothioconazole and an ascaroside where a weight ratio of prothioconazole to ascaroside is greater than 1000:1. In certain embodiments, the disclosure provides blends of prothioconazole and an ascaroside where a weight ratio of prothioconazole to ascaroside is greater than 1500:1, greater than 2000:1, greater than 3000:1, greater than 5000:1, greater than 7500:1, or greater than 10,000:1.

In certain embodiments, the disclosure provides blends of prothioconazole and an ascaroside characterized in that the blended product is labeled for application to crops at a rate that is lower than the label rate of prothioconazole alone. In certain embodiments, the blend is characterized in that the lowest label application rate delivers less than 4 oz of prothioconazole per acre, less than 3 oz. less than 2.5 oz, less than 2 oz, or less than 1 oz of prothioconazole per acre. In certain embodiments, such blends are characterized in that they are more efficacious at reducing fungal disease on the crops to which they are applied than prothioconazole applied alone at full label rate (e.g., 4-10 oz per acre).

In certain embodiments, the disclosure provides blends of propiconazole and an ascaroside where a weight ratio of propiconazole to ascaroside is greater than 1000:1. In certain embodiments, the disclosure provides blends of propiconazole and an ascaroside where a weight ratio of propiconazole to ascaroside is greater than 1500:1, greater than 2000:1, greater than 3000:1, greater than 5000:1, greater than 7500:1, or greater than 10,000:1.

In certain embodiments, the disclosure provides blends of propiconazole and an ascaroside characterized in that the blended product is labeled for application to crops at a rate that is lower than the label rate of propiconazole alone. In certain embodiments, the blend is characterized in that the lowest label application rate delivers less than 4 oz of propiconazole per acre, less than 3 oz. less than 2.5 oz, less than 2 oz, or less than 1 oz of propiconazole per acre. In certain embodiments, such blends are characterized in that they are more efficacious at reducing fungal disease on the crops to which they are applied than propiconazole applied alone at full label rate (e.g. 4-10 oz per acre).

### Ascaroside+Strobilurin Fungicides

In some embodiments, the disclosure provides compositions and methods relating to an ascaroside and a strobilurin (e.g., azoxystrobin, kresoxim-methyl, picoxystrobin, pyraclostrobin, trifloxystrobin, famoxadone, or fenamidone). In some embodiments, the ascaroside can be used with any strobilurin fungicide or any fungicide that inhibits mitochondrial respiration, or more particularly, any fungicide that binds to a quinol binding site of a cytochrome complex (e.g., a quinone outside inhibitor or QₒI). In certain embodiments, the ascaroside can be used with any strobilurin fungicide (e.g., with a member of the class of natural products known collectively as strobilurins, or with any material referred to as a strobilurin fungicide including synthetic analogs, derivatives or mimics of strobilurin natural products or with compositions comprising synthetic molecules having a similar structure or mode of action to strobilurins including fenamidone and famoxadone). The use of the fungicide with at least one ascaroside enhances the activity of the fungicide such that lesser amounts of the fungicide are needed. Used with an ascaroside, the fungicide is better able to control or prevent plant disease resulting in better plant growth and yield. Additionally, the activity of the ascaroside may be enhanced by application with the fungicide such that less of the ascaroside may be needed.

According to the present disclosure, ascarosides can be used in combination with QₒI fungicides, particularly strobilurins, to enhance fungicidal activity. QₒI fungicides include but are not limited to strobilurins, Azoxystrobin, Picoxystrobin, Trifloxystrobin, Orysastrobin, Pyraclostrobin, Fenamistrobin, Dimoxystrobin, Fluoxastrobin, Metaminostrobin, Mandestrobin, Pyrametostrobin, Pyrazoxystrobin, Kresoxim-methyl, Fenamidone, and Famoxadone.

As discussed, strobilurins or a fungicide having the same mode of action as strobilurins can be used in the practice of the invention. Mixtures of fungicides are also encompassed, particularly fungicides that are used in combination with strobilurins. Such fungicides used with strobilurins include, but are not limited to, boscalid, tebuconazole, propiconazole, Myclobutanil, Epoxiconazole, Ipconazole, Metconazole, Uniconazole-P, Uniconazole, Triticonazole, Tricyclazole, Triazbutil, Triadimenol, Triadimefon, Tetraconazole, Tebuconazole, Simeconazole, Quinconazole, Prothioconazole, Propiconazole, Penconazole, Imibenconazole, Hexaconazole, Furconazole, Furconazole-cis, Flutriafol, Flusilazole, Fluquinconazole, Fluotrimazole, Fenbuconazole, Etaconazole, Diniconazole-M, Diniconazole, Difenoconazole, Diclobutrazol, Cyproconazole, Bromuconazole, Bitertanol, Azaconazole, Amisulbrom fluopyram, benzovindiflupyr, and the like.

Azoxystrobin (IUPAC: methyl (E′)-2-,2-[6-(2-cyanophenoxy)pyrimidin-4-yl]oxyphenyl]-3-methoxyprop-2-enoate) is a synthetic chemical produced primarily for its fungicidal properties. Azoxystrobin is a xylem-mobile systemic fungicide with translaminar, protectant and curative properties. It is a member of the class of compounds strobilurins. Azoxystrobin is effective against numerous fungal plant pathogens including members of the phyla Ascomycota, Deuteromycota, and Basidiomycota, as well as the oomycetes. In addition, its properties mean that it can move systemically through plant tissue to protect parts of the crop that were not in contact with the spray. Important diseases which it controls include leaf spot, rusts, powdery mildew, downy mildew, net blotch and blight. Worldwide, azoxystrobin is registered for use on all important crops. For example, in the European Union and United States, it is registered for use in wheat, barley, oats, rye, soya, cotton, rice, strawberry, peas, beans, onions and many other vegetables. Azoxystrobin may be applied alone or as a tank mix with other agents, such as fungicides, insecticides, herbicides, or other crop agents. While any source of azoxystrobin can be used, it is sold under various tradenames including Amistar, Abound, Heritage, Olympus, Ortiva, Priori Xtra, Scotts DiseaseEx, Haedes and Quadris. Suppliers and additional brand names used in the United States are listed in the National Pesticide Information Retrieval System.

Azoxystrobin is typically formulated as a 2 lb/gal suspension concentrate formulation. Application is made using ground or aerial equipment at 0.1-0.25 lb ai/A/application (0.100-0.200 kg ai/ha/application). The proposed maximum seasonal rates range 1.5 lb ai/A, and the proposed retreatment intervals are 14-21 days. Using azoxystrobin with at least one ascaroside of the invention increases the activity of the fungicide and makes it more efficient in reducing the severity of the disease and for its control. Thus, lower concentrations or rates of azoxystrobin are needed.

Picoxystrobin (IUPAC: (E)-Methyl 3-methoxy-2-(2-(((6-(trifluoromethyl)pyridin-2-yl)oxy)methyl)phenyl)acrylate) is a systemic fungicide and delivers both curative and preventative control of diseased plants. Picoxystrobin is a synthetic chemical produced primarily for its fungicidal properties. Picoxystrobin is a xylem-mobile systemic fungicide with translaminar, protectant and curative properties. It is a member of the class of compounds strobilurins. Picoxystrobin is effective against numerous fungal plant pathogens including members of the phyla Ascomycota, Deuteromycota, and Basidiomycota, as well as the oomycetes. In addition, its properties mean that it can move systemically through plant tissue to protect parts of the crop that were not in contact with the spray. Important diseases which it controls include leaf spot, rusts, powdery mildew, downy mildew, net blotch and blight. Picoxystrobin is currently registered in many countries, including: Argentina, Austria, Belgium, Brazil, Canada, Colombia, Czech Republic, Denmark, Estonia, Finland, France, Germany, Hungary, Ireland, Kenya, Latvia, Lithuania, the Netherlands, New Zealand, Norway, Poland, Romania, Slovakia, South Africa, Sweden, USA and the UK.

Picoxystrobin is marketed as a single ingredient fungicide and also in several mixtures with other fungicides, including: cyproconazole (Furlong, Stinger and Aproach Prima); chlorothalonil (Credo and Plinker); and cyprodinil (Acanto Prima). Picoxystrobin may be applied alone or as a tank mix with other agents, such as fungicides, insecticides, herbicides, or other crop agents. While any source of picoxystrobin can be used, it is sold under various tradenames including Aproach, Acapela, Cerefit, and Prima. Suppliers and additional brand names used in the United States are listed in the National Pesticide Information Retrieval System.

Picoxystrobin is typically supplied as a solution concentrate (SC) formulated for application at rates of 0.05 to 0.2 lbs AI per acre. Spray volume may range from about 5 up to 300 gallons of finished spray per acre depending upon equipment, plant species and plant growth stage at time of application. Using picoxystrobin with at least one ascaroside of the invention in various manners as outlined herein below increases the activity of the fungicide and makes it more efficient in reducing the severity of the disease and for its control. Thus, lower concentrations or rates of azoxystrobin are needed.

In certain embodiments, the disclosure provides blends of a strobilurin fungicide and an ascaroside where a weight ratio of the strobilurin fungicide to ascaroside is greater than 1000:1. In certain embodiments, the disclosure provides blends of a strobilurin fungicide and an ascaroside where a weight ratio of the strobilurin fungicide to ascaroside is greater than 1500:1, greater than 2000:1, greater than 3000:1, greater than 5000:1, greater than 7500:1, or greater than 10,000:1.

In certain embodiments, the disclosure provides blends of a strobilurin fungicide and an ascaroside characterized in that the blended product is labeled for application to crops at a rate that is lower than the label rate of the strobilurin fungicide alone. In certain embodiments, the blend is characterized in that the lowest label application rate delivers less than 4 oz of a strobilurin fungicide per acre, less than 3 oz. less than 2.5 oz, less than 2 oz, or less than 1 oz of a strobilurin fungicide per acre. In certain embodiments, such blends are characterized in that they are more efficacious at reducing fungal disease on the crops to which they are applied than a strobilurin fungicide applied alone at full label rate (e.g. 4-10 oz per acre).

In certain embodiments, the disclosure provides blends of azoxystrobin and an ascaroside where a weight ratio of azoxystrobin to ascaroside is greater than 1000:1. In certain embodiments, the disclosure provides blends of azoxystrobin and an ascaroside where a weight ratio of the azoxystrobin to ascaroside is greater than 1500:1, greater than 2000:1, greater than 3000:1, greater than 5000:1, greater than 7500:1, or greater than 10,000:1.

In certain embodiments, the disclosure provides blends of azoxystrobin and an ascaroside characterized in that the blended product is labeled for application to crops at a rate that is lower than the label rate of azoxystrobin alone. In certain embodiments, the blend is characterized in that the lowest label application rate delivers less than 4 oz of azoxystrobin per acre, less than 3 oz., less than 2.5 oz, less than 2 oz, or less than 1 oz azoxystrobin per acre. In certain embodiments, such blends are characterized in that they are more efficacious at reducing fungal disease on the crops to which they are applied than azoxystrobin applied alone at full label rate (e.g., 4-10 oz per acre).

### Ascaroside+SDHI Fungicides

In some embodiments, the disclosure provides compositions and methods relating to an ascaroside and a succinate dehydrogenase inhibitor (SDHI) fungicide. Succinate dehydrogenase (SDH) complex II is considered to be an essential component of the mitochondrial respiratory chain in fungi. SDH enzymes transfer succinate-derived electrons directly to the ubiquinone pool of the respiratory chain, promoting energy transfer in the mitochondria. Succinate dehydrogenase inhibitors (SDHIs) are a class of fungicides that act on mitochondrial SDH complex II, blocking cellular energy transfer, thereby inhibiting the development of fungi. Many SDHIs inhibit fungal respiration by blocking the ubiquinone binding (Qp) site. SDHIs that bind strongly to the Qp site, physically block access to the ubiquinone substrate which consequently prevents further cycling of succinate oxidation.

SDHI fungicides include, but are not limited to, benzamide fungicides that inhibit succinate dehydrogenase (SDH) complex II. Examples of benzamide SDHI fungicides include, but are not limited to, benodanil, flufenoxadiazam, flutolanil, mebenil, mepronil, salicylanilide, fluopyram, benzohydroxamic acid, flumetover, fluopicolide, fluopimomide, tioxymid, trichlamide, zarilamid, and zoxamide. SDHI fungicides also include carboxamide fungicides that inhibit succinate dehydrogenase (SDH) complex II. Carboxamide fungicides that inhibit SDH include, but are not limited to: oxathiin fungicides, furan carboxamide fungicides, pyrazine carboxamide fungicides, pyrazole carboxamide fungicides, and pyridine carboxamide fungicides. Examples of oxathiin fungicides include, but are not limited to, carboxin and oxycarboxin. Examples of furan carboxamide fungicides include, but are not limited to, fenfuram, furcarbanil, or methfuroxam. An example of a pyrazine carboxamide fungicide is pyraziflumid. Examples of pyrazole carboxamide fungicides include, but are not limited to, benzovindiflupyr, bixafen, flubeneteram, fluindapyr, fluxapyroxad, furametpyr, inpyrfluxam, isoflucypram, isopyrazam, penflufen, penthiopyrad, pydiflumetofen, pyrapropoyne, sedaxane, ethaboxam, and thifluzamide. Examples of pyridine carboxamide fungicides include, but are not limited to, boscalid or cyclobutrifluram. SDHI fungicides also include thiopheneamide fungicides that inhibit SDH complex II, for example, isofetamid.

In certain embodiments, the disclosure provides blends of an SDHI fungicide and an ascaroside where a weight ratio of an SDHI fungicide to ascaroside is greater than 1000:1. In certain embodiments, the disclosure provides blends of an SDHI fungicide and an ascaroside where a weight ratio of an SDHI fungicide to ascaroside is greater than 1500:1, greater than 2000:1, greater than 3000:1, greater than 5000:1, greater than 7500:1, or greater than 10,000:1.

In certain embodiments, the disclosure provides blends of tebuconazole and an ascaroside characterized in that the blended product is labeled for application to crops at a rate that is lower than the label rate of an SDHI fungicide alone. In certain embodiments, the blend is characterized in that the lowest label application rate delivers less than 4 oz of an SDHI fungicide per acre, less than 3 oz. less than 2.5 oz, less than 2 oz, or less than 1 oz of an SDHI fungicide per acre. In certain embodiments, such blends are characterized in that they are more efficacious at reducing fungal disease on the crops to which they are applied than an SDHI fungicide applied alone at full label rate (e.g., 4-10 oz per acre).

### Multi-Way Blends

In certain embodiments, the disclosure provides blends and/or products intended for co-application to crops containing one or more ascarosides and at least two additional active agents. In certain embodiments, such products comprise ascaroside(s) and a blend of two or more chemical fungicides. In certain embodiments, the two or more chemical fungicides are from the same chemical class (e.g., two different triazoles as in Example 4 below). In certain embodiments, the two or more chemical fungicides are from the different chemical classes (e.g., a triazole and a strobilurin as in Examples 2 and 8 below; or a triazole and an SDHI as in Example 6).

In certain embodiments, the disclosure provides blends and/or products intended for co-application to crops containing one or more ascarosides and two or more different triazole fungicides (e.g., such as the triazole fungicides described more fully above). In certain embodiments, the disclosure provides blends and/or products intended for co-application to crops containing one or more ascarosides and two or more different strobilurin fungicides (e.g., such as the strobilurin fungicides described more fully above). In certain embodiments, the disclosure provides blends and/or products intended for co-application to crops containing one or more ascarosides and two or more different SDHI fungicides (e.g. such as the SDHT fungicides described more fully above). In certain embodiments, the disclosure provides blends and/or products intended for co-application to crops containing one or more ascarosides, at least one triazole fungicide, and at least one strobilurin fungicide. In certain embodiments, the disclosure provides blends and/or products intended for co-application to crops containing one or more ascarosides, at least one triazole fungicide, and at least one SDHI fungicide. In certain embodiments, the disclosure provides blends and/or products intended for co-application to crops containing one or more ascarosides, at least one strobilurin fungicide, and at least one SDHI fungicide.

In certain embodiments, the disclosure provides blends and/or products intended for co-application to crops containing one or more ascarosides and at least two different chemical fungicides are characterized in that the weight ratio of chemical fungicides to ascarosides(s) is greater than 1000:1. In certain embodiments, the disclosure provides blends and/or products intended for co-application to crops containing one or more ascarosides and at least two different chemical fungicides wherein the weight ratio of chemical fungicides to ascarosides(s) is greater than 1500:1, greater than 2000:1, greater than 3000:1, greater than 5000:1, greater than 7500:1, greater than 10,000:1, greater than 20,000:1, or greater than 30,000:1.

In certain embodiments, the disclosure provides blends and/or products intended for co-application to crops containing one or more ascarosides and at least two different chemical fungicides are characterized in that the blended product is labeled for application to crops at a rate that is lower than the label rate of the chemical fungicides formulated without ascaroside(s).

### Use(s) and Composition(s)

As noted above, the disclosed treatment with an ascaroside and an additional active agent (e.g., including, but not limited to, a triazole, strobilurin, or SDHI fungicide as described in detail above) can be used to significantly reduce disease, to promote plant growth and/or yield, and to reduce reliance on traditional pesticides. The term “treat” or “treating” or its derivatives includes substantially inhibiting, slowing, or reversing the progression of a condition, substantially ameliorating symptoms of a condition, or substantially preventing the appearance of symptoms or conditions brought about by one or more pathogens (e.g., fungal pathogens). The terms “controlling” and “protecting a plant from a pathogen” refers to one or more of inhibiting or reducing the growth, germination, reproduction, and/or proliferation of a pathogen of interest; and/or killing, removing, destroying, or otherwise diminishing the occurrence, and/or activity of a pathogen of interest. As such, a plant treated according to the present disclosure may show a reduced disease severity or reduced disease development in the presence of plant pathogens by a statistically significant amount. The term “prevent” and its variations means controlling a disease state prior to fungal or bacterial proliferation or infestation. In this instance, the composition is applied before exposure to the pathogens. The term “inhibit” and all variations of this term is intended to encompass the restriction or prohibition of fungal or pest growth.

In some embodiments, treatment with an ascaroside and an additional active agent provides additive effects and/or more than additive effects and/or synergistic effects. As one of skill in the art is aware, synergy occurs when the combined effect of two or more active agents is more than the sum of the effects the active agents would have individually. As such, in the context of the present disclosure, synergy is demonstrated where the combined effect of the ascaroside and the additional active agent exhibits a greater effect than the individual effect of the ascaroside plus the individual effect of the additional active agent (e.g., with regard to greater antiparasitic activity, broader antiparasitic activity, increased yield, or the like). Treatment with an ascaroside and an additional agent can, in some embodiments, result in better-than-expected results than treatments with just the individual active agents (e.g., ascaroside and additional active agent) alone. Thus, a plant or plant part treated with an effective amount of the components described herein may show a reduced disease severity or reduced disease development in the presence of pathogens by a statistically significant amount. A reduced disease severity or reduced disease development can be a reduction of about 30% to about 40%, to about 50%, to about 60%, to about 70%, to about 80%, to about 90%, or to about 100% when compared to nontreated control plants. In other instances, the plant treated with the active agent (e.g., fungicide) provided herein may show a reduced disease severity or reduced disease development in the presence of plant pathogen at least about 25%, at least about 40%, at least about 50%, at least about 51%, about 60%, about 70% about 80%, about 90%, about 91%, about 92%, about 93%, about 94%, about 95%, about 96%, about 97%, about 98%, about 99%, or about 100% when compared to non-treated control plants

In some embodiments, treatment with an ascaroside and an additional active agent as provided herein provides a wider spectrum of antiparasitic activity (e.g., controlling several diseases occurring simultaneously in a given crop).

In some embodiments, treatment with an ascaroside and an additional active agent as provided herein can reduce the amount of the additional active agent needed to achieve a comparable result as seen without inclusion of the ascaroside. For example, less of the additional active ingredient (e.g., fungicide or fungicide mixture) or less of the ascaroside may be required to achieve beneficial results and control the pathogen (e.g., fungal pathogen) or fewer sprays may be needed during the growing season. In some embodiments, the amount of active agent (e.g., fungicide) needed for the prevention or treatment of plant diseases may be reduced by about 5%, about 10%, about 20%, about 30%, about 40%, about 50%, about 60%, about 70%, about 90% or more. In some embodiments, the rate of active agent (e.g., fungicide) applied is about ¼ X or about ¼ X label field use rate, about ⅓X or about ⅓X label field use rate, or about ½X or about ½X label field use rate for said pathogen. Likewise, the amount of ascaroside composition may be reduced as well. The ascaroside(s) may be reduced by about 5%, about 10%, about 20%, about 30%, about 40%, about 50%, about 60%, about 70%, about 90% or more.

In some embodiments, treatment with an ascaroside and an additional active agent as provided herein can afford additional benefits, e.g., increased plant health, growth and/or yield. An increase in yield can comprise any statistically significant increase including, but not limited to, at least a 1% increase, at least a 3% increase, at least a 5% increase, at least a 10% increase, at least a 20% increase, at least a 30% increase, at least a 50% increase, at least a 70% increase, at least a 100% or a greater increase in yield compared to a plant not exposed to these two components.

The one or more ascarosides and one or more additional active agents (e.g., including but not limited to, triazoles, strobilurins, and SDHIs, as described in detail above) are generally applied in effective amounts. An effective amount is an amount sufficient to control, treat, prevent, or inhibit the plant pathogen, and/or reduce plant disease severity or reduce plant disease development. By controlling plant disease, the effective amount improves an agronomic trait of interest, as well as promotes and increases plant health, growth, and yield. The one or more ascarosides and one or more active agents can be applied to plants in a variety of ways. In some embodiments, the one or more ascarosides and the one or more additional active agents are co-applied, either within separate formulations/agricultural composition (e.g., such that both the one or more ascarosides and the one or more additional active agents are applied within a given time period of each other), or within the same formulation/agricultural composition.

Co-application can, in some embodiments, involve application of two separate formulations (one comprising the one or more ascarosides and one comprising the one or more additional active agents) at close time points, e.g., substantially simultaneously or within about 1 minute, within about 5 minutes, within about 10 minutes, within about 30 minutes, within about an hour, within about 4 hours, within about 6 hours, within about 12 hours, within about 24 hours, or within about 2 days of one another). When the one or more ascarosides and the additional active agent are applied separately, the one or more ascarosides can be applied before or after application of the additional active agent.

Co-application, can, in some embodiments, involve combining the one or more ascarosides and the one or more additional active agents shortly before application (e.g., immediately prior to application) to the plants. One suitable method for administering the one or more ascarosides and the one or more additional active agents is to mix the components in the field; for example, the one or more ascarosides can be added to a fully formulated tank mix comprising the one or more additional active agents.

In other embodiments, the components to be co-applied can be combined at a timepoint further in advance of application. In such embodiments, an agricultural formulation is prepared, the formulation comprising one or more ascarosides and the one or more additional active agents in combination with one or more inert ingredients. Advantageously, in some embodiments, combinations of the one or more ascarosides and the one or more additional active agents are provided herein which are compatible with one another and the resulting formulations can demonstrate stability over long periods of time (e.g., one week or more, one month or more, two months or more, three months or more, four months or more, five months or more, or six months or more), e.g., under standard conditions (e.g., room temperature and contained in a closed system in one or more of the relative humidity zones). Demonstration of stability in this context can vary. For example, in some embodiments, no noticeable separation is observed by the naked eye. In some embodiments, no significant change to the amount of active ingredient and/or ascaroside is observed via conventional methods (e.g., spectroscopy). In some embodiments, no significant chemical degradation of active ingredient and/or ascaroside is observed using conventional methods (e.g., spectroscopy).

Such formulations comprising both the one or more ascarosides and the one or more additional active agents can vary in composition and form. In some embodiments, such formulations are in solid form and in some embodiments, such formulations are in liquid form. As referenced, in addition to the one or more ascarosides and the one or more additional active agents, one or more inert ingredients, e.g., one or more agronomically acceptable carriers (also referred to as agriculturally acceptable or suitable adjuvants) are generally included within the formulation. It is preferred that non-toxic carriers be used in the formulations and methods of the present disclosure. The term “agronomically acceptable carrier” includes any carrier suitable for administration to a plant or soil, e.g., customary excipients in formulation techniques, such as used to form solutions (e.g., directly sprayable or dilutable solutions), emulsions, (e.g., emulsion concentrates and diluted emulsions), wettable powders, suspensions, soluble powders, powders, dusts, pastes, soluble powders, granules, suspension-emulsion concentrates, encapsulation into polymeric materials, coatable pastes, natural and synthetic materials impregnated with active compound and microencapsulations in polymeric substances. In some embodiments, agronomically acceptable carriers can include surfactants, emulsifiers, oils, salts, and the like.

These compositions can be produced in a known manner, for example, by mixing the one or more ascarosides and the one or more additional active agents with one or more agronomically acceptable carriers, such as liquid solvents or solid carriers, optionally with the use of additional components including, but not limited to, surfactants, including emulsifiers, dispersants, foam-formers, colorants, processing aids, lubricants, fillers, reinforcements, flame retardants, light stabilizers, ultraviolet radiation absorbers, weather stabilizers, plasticizers, release agents, perfumes, heat-retaining additives (e.g., silica), cross-linking agents, antioxidants, anti-foaming agents, buffers, pH modifiers, compatibility agents, drift control additives, extenders/stickers, tackifiers, plant penetrants, safeners, spreaders, wetting agents, and the like. In some embodiments, such formulations can include one or more additional active agents and/or one or more plant or plant product treatment compounds. Further, some compositions will be residual in that they do not easily wash off the leaves of a plant during rain and thus can protect against pests during and after rainy weather. The additional components noted herein can be added directly into the formulation as referenced above or alternatively can be added separately, e.g., at the time of application. In some embodiments, wetting agents, emulsifiers, spreaders, and the like are used in the formulations. Formulations include concentrated versions, in which the active agent is present in a concentration of from 0.001 to 98.0%, with the remaining content being agronomically acceptable carriers/adjuvants.

Such formulations, especially those with less than 50 percent of the present compound, can sometimes be used directly, but these formulations can also be diluted with other agronomically acceptable carriers to form more dilute treating formulations. These latter formulations can include the compounds described herein in lesser concentrations of from 0.001 to 0.1 percent.

The formulations may additionally contain “adjuvant surfactants” to enhance deposition, wetting, and penetration of the compounds onto the target crop and organism. These “adjuvant surfactants” may optionally be employed as a component of the formulation or as a tank mix. The amount of adjuvant surfactant will typically vary from 0.01 to 1.0 percent by volume, based on a spray-volume of water, preferably 0.05 to 0.5 volume percent. Suitable adjuvant surfactants include, but are not limited to ethoxylated nonyl phenols, ethoxylated synthetic or natural alcohols, salts of the esters or sulfosuccinic acids, ethoxylated organosilicones, ethoxylated fatty amines, blends of surfactants with mineral or vegetable oils, crop oil concentrate (mineral oil (85%)+emulsifiers (15%)); nonylphenol ethoxylate; benzylcocoalkyldimethyl quaternary ammonium salt; blend of petroleum hydrocarbon, alkyl esters, organic acid, and anionic surfactant; C9-Cu alkylpolyglycoside; phosphated alcohol ethoxylate; natural primary alcohol (C12-C16) ethoxylate; di-sec-butylphenol EO-PO block copolymer; polysiloxane-methyl cap; nonylphenol ethoxylate+urea ammonium nitrate; emulsified methylated seed oil; tridecyl alcohol (synthetic) ethoxylate (8EO); tallow amine ethoxylate (15 EO); PEG(400) dioleate-99. The formulations may also include oil-in-water emulsions. If the agronomically acceptable carrier is water, in some embodiments, an organic solvent may be incorporated as an auxiliary liquid solvent. Suitable liquid solvents include, for example, aromatics (e.g., xylene, toluene and alkylnaphthalenes); chlorinated aromatics or chlorinated aliphatic hydrocarbons (e.g., chlorobenzenes, chloroethylenes and methylene chloride); aliphatic hydrocarbons (e.g., cyclohexane); paraffins (e.g., petroleum fractions, mineral and vegetable oils); alcohols (e.g., butanol or glycol and their ethers and esters); ketones (e.g., acetone, methyl ethyl ketone, methyl isobutyl ketone and cyclohexanone) and strongly polar solvents (e.g., dimethylformamide and dimethyl sulfoxide). Other examples of organic solvents include, but are not limited to, xylene, propyl benzene fractions; or mixed naphthalene fractions, mineral oils, substituted aromatic organic liquids such as dioctyl phthalate; kerosene; dialkyl amides of various fatty acids, particularly the dimethyl amides of fatty glycols and glycol derivatives such as the n-butyl ether, ethyl ether or methyl ether of diethylene glycol, the methyl ether of triethylene glycol, petroleum fractions or hydrocarbons such as mineral oil, aromatic solvents, paraffinic oils, and the like; terpenic solvents, rosin derivatives, aliphatic ketones such as cyclohexanone, complex aliphatic and aromatic alcohols such as 2-ethoxyethanol, vegetable oils such as soy bean oil, rape seed oil, olive oil, castor oil, sunflower seed oil, coconut oil, com oil, cotton seed oil, linseed oil, palm oil, peanut oil, safflower oil, sesame oil, tung oil and the like; esters of the above vegetable oils; and the like. Mixtures of two or more organic liquids may also be employed in the preparation of certain emulsifiable concentrates. Organic liquids include xylene, and propyl benzene fractions, with xylene being most preferred in some cases. Surface-active dispersing agents are typically employed in liquid formulations and in an amount of from 0.1 to 20 percent by weight based on the combined weight of the dispersing agent with one or more of the compounds.

Suitable solid agronomically acceptable carriers include, for example, ammonium salts and ground natural minerals (e.g., kaolins, clays, talc, chalk, quartz, attapulgite, montmorillonite and diatomaceous earth); ground synthetic minerals (e.g., highly disperse silica, alumina and silicates); crushed and fractionated natural rocks (e.g., calcite, marble, pumice, sepiolite and dolomite); synthetic granules of inorganic and organic meals; granules of organic material (e.g., sawdust, coconut shells, maize cobs and tobacco stalks). In some embodiments, dry compositions can comprise powders and the like.

Suitable emulsifiers and foam-formers include, for example, nonionic and anionic emulsifiers (e.g., polyoxyethylene fatty acid esters, polyoxyethylene fatty alcohol ethers, for example, alkylaryl polyglycol ethers, alkylsulfonates, alkyl sulphates and arylsulfonates) protein hydrolysates. Suitable dispersants include, for example, lignin-sulfite waste liquors and methylcellulose. Tackifiers such as carboxymethylcellulose and natural and synthetic polymers in the form of powders, granules or lattices, such as gum arabic, polyvinyl alcohol and polyvinyl acetate, as well as natural phospholipids, such as cephalins and lecithins, and synthetic phospholipids, can be used in the disclosed compositions. Examples of nonionic emulsifiers useful in preparing the emulsifiable concentrates include the polyalkylene glycol ethers and condensation products of alkyl and aryl phenols, aliphatic alcohols, aliphatic amines or fatty acids with ethylene oxide, propylene oxides such as the ethoxylated alkyl phenols and carboxylic esters solubilized with the polyol or polyoxyalkylene. Cationic emulsifiers include quaternary ammonium compounds and fatty amine salts. Anionic emulsifiers include the oil soluble salts (e.g., calcium) of alkylaryl sulphonic acids, oil-soluble salts or sulfated polyglycolethers and appropriate salts of phosphated-polyglycol ether. Other additives may include, for example, mineral and vegetable oils.

“Surfactants” (e.g., which can comprise typically about 0.5% to about 10% of a wettable powder) include sulfonated lignins, condensed naphthalene-sulfonates, the naphthalenesulfonates, alkyl-benzenesulfonates, alkylsulfonates or nonionic surfactants such as ethylene oxide adducts of alkylphenols or mixtures thereof

Colorants such as inorganic pigments, for example, iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc may also be included in the compositions.

Methods of preparing solid and liquid compositions for agrichemical use are generally known and can be employed according to the present disclosure (where such methods involve incorporating one or more ascarosides and one or more additional active agents) within such compositions). In some embodiments, compositions can be utilized as liquid concentrates, Ready-to-Use (RTU) liquid sprays, dusts, or solids, depending upon the needs of the user. Compositions according to the present disclosure can, in some embodiments, be in the form of granular material (including dusts, pellets, soluble powders, flowable powders, water-dispersible granules, and the like). In some embodiments, compositions according to the present disclosure can be in liquid form (e.g., solutions, suspensions, or emulsions). In some embodiments, compositions are in the form of a granular material treated with a liquid comprising the one or more ascarosides and the one or more additional active agents. In some embodiments, a composition comprising one or more ascarosides and one or more additional active agents is formed into fibers or filaments and in some such embodiments, a woven or non-woven textile (e.g., film) can be produced therefrom. In some embodiments, a composition as provided herein is pelletized. In some embodiments, a composition as provided herein is in the form of a film, e.g., plastic mulch. Any of the solid compositions provided herein can optionally be coated via methods generally known in the art to delay release of the one or more ascarosides and the one or more additional active agents. The formulation chosen will depend on the use of the product.

Dusts containing the compounds of the present disclosure may be prepared by intimately mixing one or more of the compounds in powdered form with a suitable dusty agricultural carrier, such as, for example, kaolin clay, ground volcanic rock, and the like. Dusts can suitably contain from about 1 to about 10 weight percent of the compounds, based on the total weight of the dust.

Wettable powders may be agglomerated or compacted to form water dispersible granules. These granules can include mixtures of compound, inert carriers suitable for granular applications and surfactants. The concentration of the compound is typically between about 0.1% to about 90% by weight. The “inert carrier suitable for granular applications” is typically pyrophyllite, talc, chalk, gypsum, Fuller's earth, bentonite, attapulgite, starch, casein, gluten, montmorillonite clays, diatomaceous earths, purified silicates, or the like. In such operations, the finely divided carrier and surfactants are typically blended with the compound(s) and milled.

“Aqueous suspensions” may be prepared where the compounds are dispersed in an aqueous vehicle at a concentration typically in the range of between about 5% to about 50% by weight. The suspensions can be prepared by finely grinding the compound and vigorously mixing it into a vehicle of water, surfactants, and dispersants. Inert ingredients such as inorganic salts and synthetic or natural gums may also be employed to increase the density and/or viscosity of the aqueous vehicle as is desired.

The amount of the one or more ascarosides and the one or more active agents included within such formulations can vary. In certain specific embodiments, the amount of the one or more ascarosides and the one or more active agents is a synergistically effective amount. Typically, the formulation will comprise a lower weight percentage of the one or more ascarosides than the one or more active agents.

In certain embodiments, provided combinations are characterized in that the synergistic amount of the one or more ascarosides represents a very low percentage of the formulation. In certain embodiments, provided combinations are characterized in that ascarosides are present in an amount of less than 1 wt. % relative to the other active ingredient(s). In certain embodiments, provided combinations are characterized in that ascarosides are present in an amount of less than 0.1 wt. % relative to the other active ingredient(s). In certain embodiments, provided combinations are characterized in that ascarosides are present in an amount of less than 0.05 wt. % relative to the other active ingredient(s). In certain embodiments, provided combinations are characterized in that ascarosides are present in an amount of less than 0.01 wt. % relative to the other active ingredient(s). In certain embodiments, provided combinations are characterized in that ascarosides are present less than 0.001 wt. % relative to the other active ingredient(s).

In certain embodiments, co-administration of one or more ascarosides and one or more additional active agents as described herein can find use in treating living plants or plant parts, soil surrounding plants, soil in which seeds/seedlings are to be planted, or plants or plant parts after harvest. Co-administration as used herein includes simultaneous application or sequential application, and can refer to administration within the same composition or in separate compositions, etc. In some embodiments, the one or more ascarosides and one or more additional active agents are applied to a plant part, i.e., a portion of a plant, e.g., one or more of a root, stem, leaf, seed, and/or flower. Such methods can be conducted at any one or more stages in the life cycle of a plant, e.g., from seed to seedling to growing plant to just prior to harvest. In certain embodiments, co-administration comprises spraying the foliage of a plant with one or more ascarosides and one or more additional active agents. In certain embodiments, co-administration comprises applying a powder or solid to the foliage of a plant. In certain embodiments, co-administration comprises treating the seeds of a plant (e.g., prior to planting) with one or more ascarosides and one or more additional active agents. In certain embodiments, co-administration comprises treating a trunk, branch or stem of a plant with one or more ascarosides and one or more additional active agents. In certain embodiments, co-administration comprises applying one or more ascarosides and one or more additional active agents to the soil in which a plant is growing or in which a plant will be grown.

The disclosed treatment methods can, in some embodiments, protect growing plants in the manner described in U.S. Pat. No. 10,136,595, which is incorporated by reference herein in its entirety. For example, such methods can enhance pathogen resistance and/or induce one or more plant defense responses (thereby inhibiting pathogen growth and/or infestation) in a plant to (or near) which the one or more ascarosides and one or more additional active agents are applied. Pathogens against which the disclosed methods can enhance resistance include, but are not limited to, oomycetes, bacteria, nematodes, viruses, and insects, e.g., including but not limited to, Pseudomonas syringae, Phytophthora infestans, Blumeria graminis, Heterodera schachtii, Meloidogyne incognita, Meloidogyne hapla, and turnip crinkle virus.

The disclosed treatment methods can further provide enhanced control of a range of plant pathogens (e.g., fungal pathogens). Such enhanced control may, in some embodiments, depend upon the selection of the one or more additional active agents. For example, by combining a given active agent with one or more ascarosides, the known activity of the active agent against certain pathogens in certain crops can be enhanced.

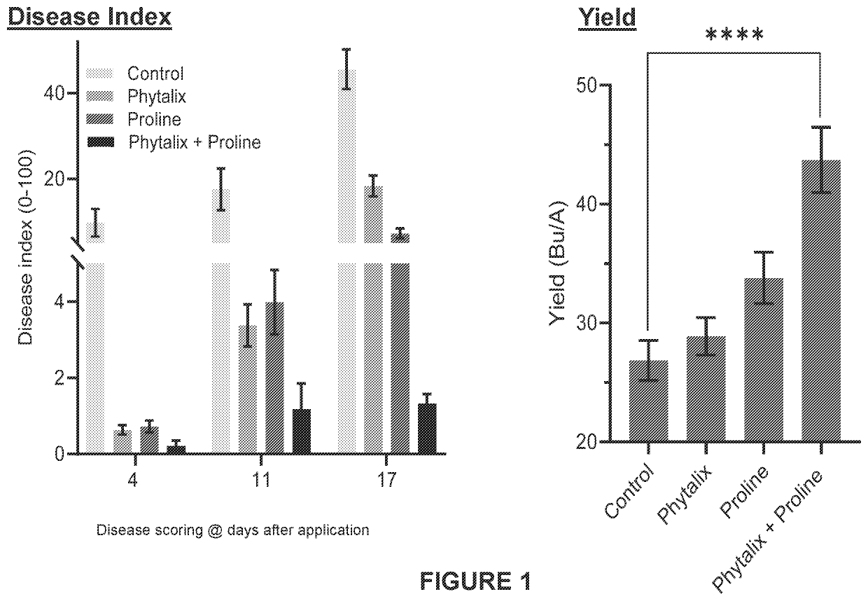

As one, non-limiting example, combinations of ascarosides with triazole fungicides have shown enhanced efficacy against fungal pathogens such as Fusarium spp. FIG. 1 shows data from a field trial where wheat was sprayed with Proline™ alone (a commercial formulation of the triazole fungicide prothioconazole), PHYTALIX®alone (a product based on ascaroside active ingredient(s)), and with a combination of PROLINE™ and PHYTALIX®. The combination product showed evidence of synergy whereby the level of disease control and wheat yield were both increased with the blend by an amount more than expected from a simple additive effect of the two products.

The exact method by which a plant or soil is treated with the one or more ascarosides and the one or more active agents is not particularly limited. Treatment of plants and/or soil according to the present disclosure can be carried out, e.g., by immersion, spraying, evaporation, fogging, scattering, painting on, side dressing, or in-furrow application. For example, in certain embodiments, plants or soil can be sprayed with one or more suitable liquid compositions, solid plastic mulch compositions can be applied on soil around plants, and/or granular compositions can be provided for in-furrow application or side-dressing. In some embodiments, the methods provided herein comprise treatment of seeds prior to planting.

The types of plants that can be treated according to the presently disclosed methods is not particularly limited and can be, for example, fruit and vegetable plants, trees, and shrubs. Non-limiting examples of plants that can be treated according to the disclosed methods include, but are not limited to, plants selected from the group consisting of tobacco, Arabidopsis, tomato, barley, potato, sweet potato, yam, cotton, soybean, strawberry, sugar beet, corn, rice, wheat, rye, oat, sorghum, millet, bean, pea, apple, banana, pear, cherry, peach, plum, apricot, almond, grape, kiwi, mango, melon, papaya, walnut, hazelnut, pistachio, raspberry, blackberry, loganberry, blueberry, cranberry, orange, lemon, grapefruit, tangerine, lettuce, carrots, onions, broccoli, cabbage, avocado, cocoa, cassava, cotton, and flax.

In some embodiments, the compositions and methods provided herein can be used to protect any plant from a fungal or bacterial disease and to promote plant health, growth, and yield, including, but not limited to, monocots and dicots. Examples of plant species of interest include, but are not limited to, corn (Zea mays), Brassica sp. (e.g., B. napus, B. rapa, B. juncea), particularly those Brassica species useful as sources of seed oil, alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Coffea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), oats, barley, vegetables, ornamentals, and conifers.

Vegetables include tomatoes (Lycopersicon esculentum), lettuce (e.g., Lactuca sativa), green beans (Phaseolus vulgaris), lima beans (Phaseolus limensis), butter beans, kidney beans (Phaseolus vulgaris), cowpeas (Vigna unguiculala), pigeon peas (Cajanus cajan), yam beans, jicama, legumes, peas (i spp.), and members of the genus i such as cucumber (C. sativus), cantaloupe (C. cantalupensis), and musk melon (C. melo). Ornamentals include azalea (Rhododendron spp.), hydrangea (Macrophylla hydrangea), hibiscus (Hibiscus rosasanensis), roses (Rosa spp.), tulips (Tulipa spp.), daffodils (Narcissus spp.), petunias (Petunia hybrida), carnation (Dianthus caryophyllus), poinsettia (Euphorbia pulcherrima), and chrysanthemum.

Conifers that may be employed in practicing the present invention include, for example, pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis). In specific embodiments, plants of the present invention are crop plants (for example, corn, alfalfa, sunflower. Brassica, soybean, cotton, safflower, peanut, sorghum, wheat, millet, tobacco, etc.). In other embodiments, a corn or soybean plants is employed.

Diseases and infestations that can be effectively reduced by treatment with one or more ascarosides and one or more fungicides according to the present disclosure can affect any part of the plant (e.g., seed, root, stem, leaves, and spikes).

Fungal and bacterial pathogens that may be controlled with the disclosed combinations include but are not limited to those selected from the group consisting of Botrytis cinerea, Cersospora spp, Cercospora sojina, Cercospora beticola, Cercospora canescens, Alternaria solani, Alternaria brassicae, Blumeria graminis f sp. Tritici, Erysiphe necator, Podosphaera xanthii, Podosphaera leucotricha, Golovinomyces cichoracearum, Erysiphe lagerstroemiae, Erysiphe cichoracearum, Erysiphe graminis, Sphaerotheca pannosa, Sphaerotheca fuliginea, Colletotrichum cereale, Apiognomonia errabunda, Apiognomonia veneta, Colletotrichum gloeosporiodes, Discula fraxinea, Plasmopara viticola, Pseudoperonospora cubensis, Peronospora belbahrii, Bremia lactucae, Peronospora lamii, Plasmopara obduscens, Pythium cryptoirregulare, Pythium aphanidermatum, Pythium irregulare, Pythium sylvaticum, Pythium myriotylum, Pythium ultimum, Phytophthora capsici, Phytophthora nicotianae, Phytophthora infestans, Phytophthora tropicalis, Phytophthora sojae, Fusarium graminearum, Fusarium solani, Fusarium oxysporum, Fusarium graminicola, Gibberella zeae, Colletotrichum graminicola, Phakopsora sp., Phakopsora meibomiae, Phakopsora pachyrizi, Puccinia triticina, Puccinia recondita, Puccinia striiformis, Puccinia graminis, Puccinia spp., Venturia inaequalis, Verticillium spp, Erwinia amylovora, Monilinia fructicola, Monilinia lax. Monilinia fructigena, Uncinula necator, Gymnosporangium sabinae, Hemileia vastatrix, Phakopsora pachyrhizi, Phakopsora meibomiae, Uromyces appendiculatus, Albugo candida, Bremia lactucae, Peronospora pisi, P. brassicae, Pseudoperonospora humuli, Pseudoperonospora cubensis, Pythium ultimum; leafspot, Cladiosporium cucumerinum, Cochliobolus sativus, Cochliobolus miyabeanus, Colletotrichum lindemuthanium, Cycloconium oleaginum, Diaporthe citri, Elsinoe fawcettii, Gloeosporium laeticolor, Glomerella cingulata, Septoria apii, Septoria lycopercisi, Fusarium oxysporum, Rhizoctonia solan, Aspergillus flavus, Fusarium culmorum, Botrytis cinerea, Sclerotinia sclerotiorum, Fusarium culmorum, Phytophthora cactorum, Pythium ultimum, Rhizoctonia solan, Rhizopus oryzae, Sclerotium rolfsii, Septoria nodorum, Botrytis cinerea, Xanthomonas oryzae, Pseudomonas lachrymans, Erwinia amylovora, Venturia inaequalis, Tilletia caries, Ustilago nuda, Ustilago avenae, Pellicularia sasakii, Pyricularia oryzae, Leptosphaeria nodorum, Pseudocercosporrela herpotrichoides, Pyrenophora teres, Pyrenophora graminea, and the like. In some embodiments, the ascarosides and one or more fungicides can be used to control Phoma leaf spot; Phoma stem canker; Powdery mildew; Yellow rust; Brown rust; Tan spot; Septoria leaf and glume blotch on cereals, including barley, rye, wheat, oats, and the like.

Particular diseases include, but are not limited to, anthracnose (Colletotrichum spp./Microdochium panattonianum in lettuce, affecting a wide range of crops), botrytis rots (e.g., grey mold/Botrytis cinerea, affecting a range of crops), downy mildews (affecting a range of crops), white blister/white rust (Albugo candida, typically in Brassicas), fusarium wilts and rots (Fusarium species including F. solani and F. oxysporum), powdery mildews (affecting a range of crops), rusts (several species, e.g., Puccinia sorghi in sweet corn; Uromyces appendiculatus in beans. Puccinia allii in spring onions, and affecting a range of crops and including e.g., Asian Soybean Rust), rhizoctonia rots (Rhizoctonia solani, commonly referred to as bottom rot in lettuce/wire stem in brassicas, affecting a range of crops), sclerotinia rots (S. sclerotiorum and S. minor, affecting most vegetable crops), sclerotium rots (Sclerotium rolfsii and S. cepivorum, affecting a range of crops), target spot (Allernaria solani. affecting tomatoes); damping off (Pythium, rhizoctonia, phytophthora, fusarium, or aphanomyces, affecting a range of crops), cavity spot (Pythium sulcatum, affecting carrots) clubroot (Plasmodiophora brassicae, typically in brassicas); tuber diseases (affecting potatoes and sweet potatoes); Pythium species (affecting many vegetable crops); leaf blight (Alternaria dauci) in carrots; black root rot (different species on different crops, affecting a range of crops), and red root complex (affecting beans); Aphanomyces root rot (Aphanomyces euteiches pv. Phaseoli, affecting beans); aschocyta collar rot (affecting peas); Gummy stem blight (Didymella bryoniae, affecting cucurbits); Alternaria leaf spot (Alternaria cucumerina and A. alternata (cucurbits)); Black leg (Leptosphaeria maculans, affecting brassicas); Ring spot (Mycosphaerella brassicicola, affecting brassicas); late blight (Septoria apiicola, affecting celery); Cercospora leaf spot (Cercospora beticola affecting beets); Leaf blight (Septoria petroelini, affecting parsley); Septoria spot (Septoria lactucae, affecting lettuce); Leaf blight (Stemphylium vesicarium, affecting spring onions); and leaf blight (Alternaria dauci, affecting carrots).

In certain embodiments, plant diseases which can be treated or reduced or prevented by the compositions and/or methods described herein include, but are not limited to, plant diseases caused by fungi, viruses or viroids, protozoa, bacteria, and the like, e.g., Asian Soybean Rust (ASR), gray mold, leaf spot, Frogeye Leaf Spot, Early Blight, Damping off complex, Brown Patch, black scurf, root rot, belly rot, sheath blight, Powdery Mildew, Anthracnose leaf spot, Downy Mildew, Pythium Blight, Late Blight, Fusarium Head Blight (FHB), sudden death syndrome (SDS), Fusarium Wilt, Corn Stalk Rot, Brown Rust, Black Rust, Yellow Rust, Wheat Rust, Rust, Apple Scab, Verticillium Wilt, Fire Blight, and Brown Rot.

### EXAMPLES

Example 1: A composition comprising an ascaroside is applied at 25 mg/acre to winter wheat crop inoculated with Fusarium Head Blight alone and in combination with a conventional fungicide (PROLINE®). The application of the Ascaroside in combination with the fungicides provided additional protection against Fusarium Head Blight.

Example 2: A composition comprising an ascaroside is applied at 250 mg/ac to soybean crops alone and in combination with certain conventional fungicides (Chlorothalonil and APROACH POWER®, comprising pioxistrobin and ciproconazole). Applications of ascaroside alone were found to provide low to modest 20-40% protection against Asian Soybean Rust. The combination of the ascaroside and the conventional fungicides provided additional protection from Asian Soybean Rust as compared with application of the fungicide alone and also resulted in improved yield.

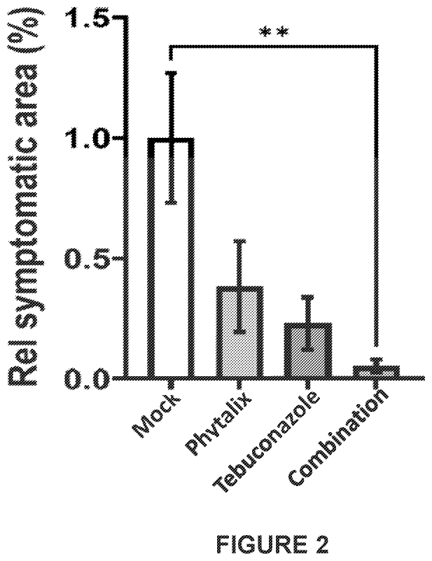

Example 3: A composition comprising a commercial ascaroside formulation PHYTALIX® and a triazole fungicide (tebuconazole) was applied via foliar spray to wheat plants grown under greenhouse and/or growth chamber conditions. The composition was applied at a rate equivalent to the label rate for tebuconazole and 25 mg/ac of ascaroside. Three control groups were treated with 1) a mock composition containing no fungicide or ascaroside, 2) a composition containing only tebuconazole (at the label rate), or 3) containing only the ascaroside composition (at 25 mg/ac equivalent). 48 hours after treatment, the plants were inoculated with the fungal pathogen Bipolaris sorokiniana. All plants were scored for disease symptoms several days after inoculation. As shown in FIG. 2, the combination treatment reduced disease systems much more effectively than either ascarosides alone or tebuconazole alone.

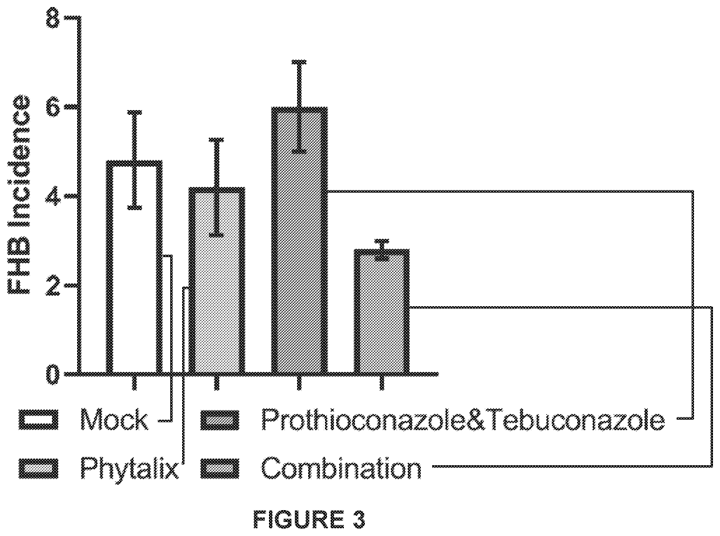

Example 4: A composition comprising a commercial ascaroside formulation PHYTALIX® and PROSARO™ (a commercial fungicide containing a mixture of two triazole fungicides tebuconazole and prothioconazole) was applied via foliar spray to wheat plants grown in a randomized small plot format under field conditions. The composition was applied at a rate equivalent to the label rate for PROSARO™ and 25 mg/ac of ascaroside. Three control groups were treated with 1) a mock composition containing no fungicide or ascaroside, 2) a composition containing only PROSARO™ (at the label rate), or 3) containing only the ascaroside composition (at 25 mg/ac equivalent). As shown in FIG. 3, the combined treatment is more effective than either product alone in reducing the incidence of Fusarium Head Blight (FHB).

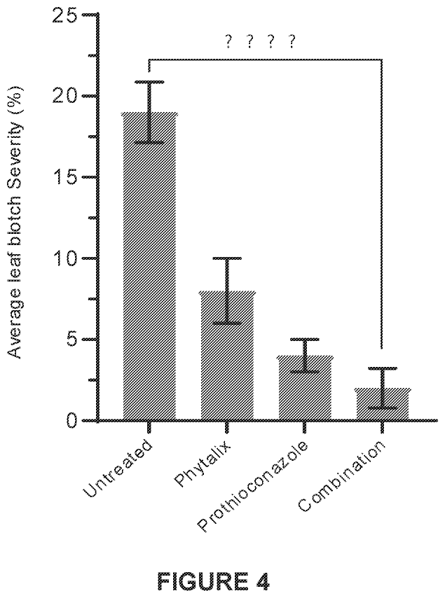

Example 5: A composition comprising a commercial ascaroside formulation PHYTALIX® and prothioconazole was applied via foliar spray to wheat plants grown in a randomized small plot format under field conditions. The composition was applied at a rate equivalent to the label rate for prothioconazole and 25 mg/ac of ascaroside. Three control groups were treated with: 1) a mock composition containing no fungicide or ascaroside, 2) a composition containing only prothioconazole (at the label rate), or 3) containing only the ascaroside composition (at 25 mg/ac equivalent). As shown in FIG. 4, the combined treatment is more effective than either product alone in reducing the severity of Septoria Leaf Blotch symptoms.

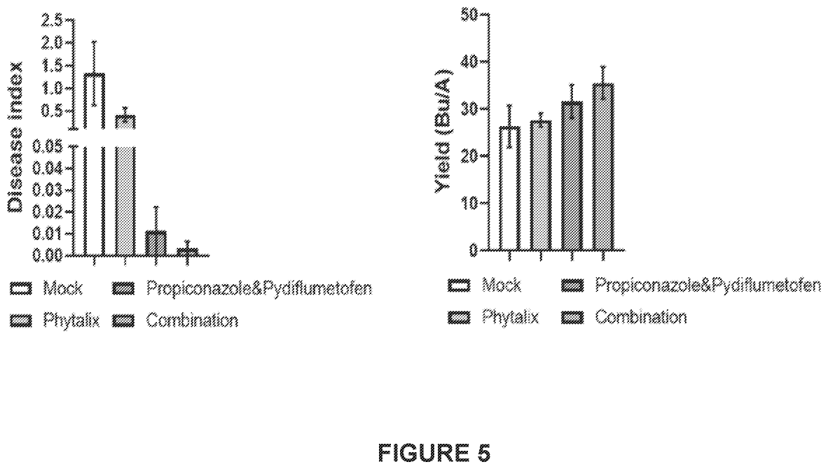

Example 6: A composition comprising a commercial ascaroside formulation PHYTALIX® and a mixture of Propiconazole and a class 7 fungicide Pydiflumetofen was applied via foliar spray to wheat plants grown in a randomized small plot format under field conditions. The composition was applied at a rate equivalent to the label rate for Propiconazole and Pydiflumetofen and 25 mg/ac of ascaroside. Three control groups were treated with: 1) a mock composition containing no fungicide or ascaroside, 2) a composition containing only Propiconazole and Pydiflumetofen (at the label rate), or 3) containing only the ascaroside composition (at 25 mg/ac equivalent). As shown in FIG. 5, the combined treatment is more effective than either product alone in reducing the severity of Fusarium Head Blight symptoms and results in a higher yield than either treatment alone.

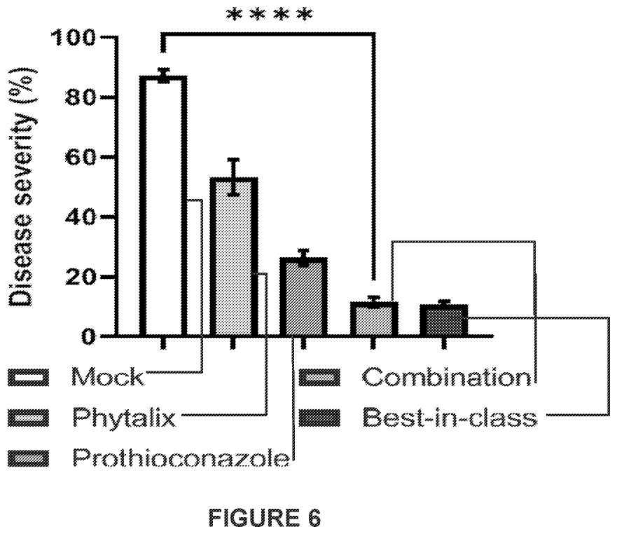

Example 7: A composition comprising a commercial ascaroside formulation PHYTALIX® and prothioconazole was applied via foliar spray to wheat plants grown in a randomized small plot format under field conditions. The composition was applied at the label rate for prothioconazole and 25 mg/ac of ascaroside. Three control groups were treated with: 1) a mock composition containing no fungicide or ascaroside, 2) a composition containing only prothioconazole (at the label rate), or 3) containing only the ascaroside composition (at 25 mg/ac equivalent). As shown in FIG. 6, the combined treatment is more effective than either product alone in reducing the severity of Fusarium Head Blight symptoms.

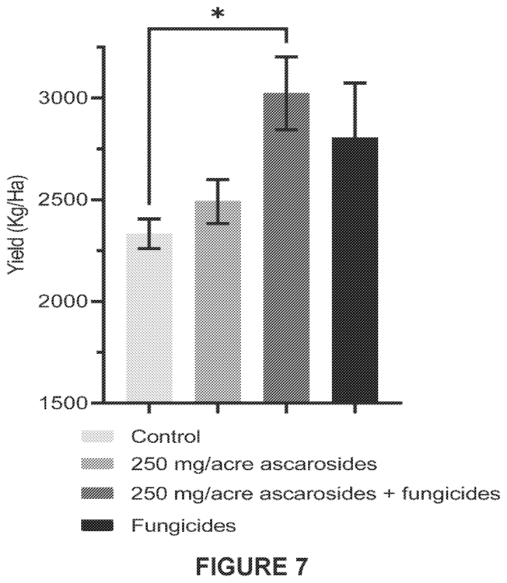

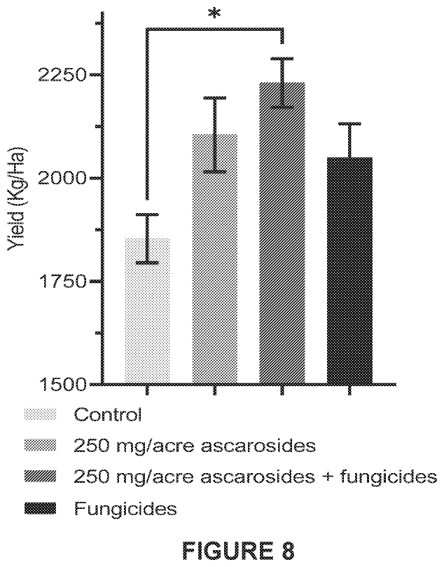

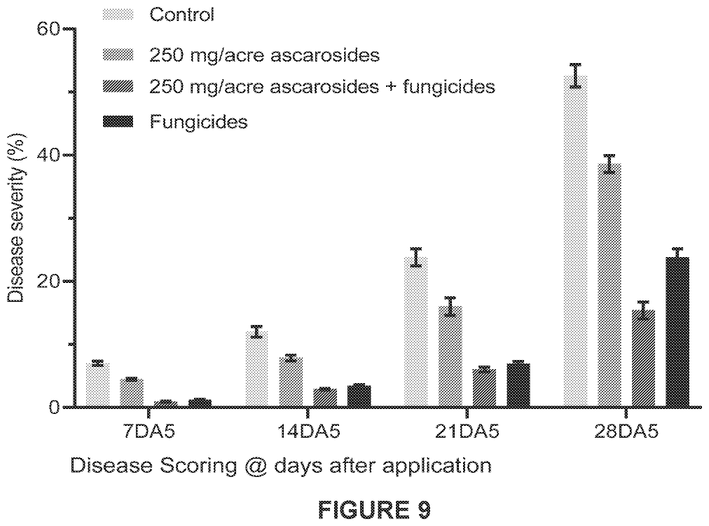

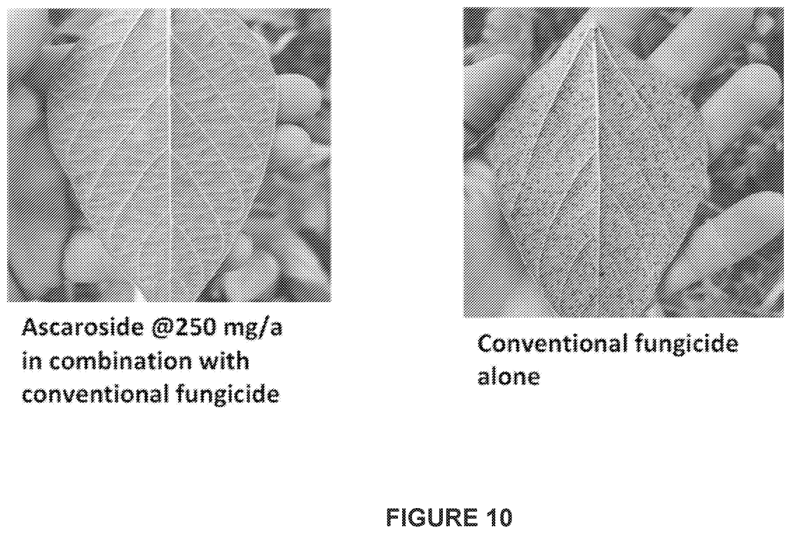

Example 8: A composition comprising an ascaroside (ascr #18) was applied via foliar spray at a rate of 250 mg/ac to soybean crops grown under field conditions at two sites in Brazil in areas prone to Asian Soybean Rust (ASR) infections. The ascaroside composition was applied alone or in combination with certain conventional fungicides (Chlorothalonil and APROACH POWER®, comprising picoxistrobin and ciproconazole) and separate control plots were either left untreated or treated with conventional fungicides alone. Applications of ascaroside alone were found to provide modest (e.g. 20-40%) protection against Asian Soybean Rust relative to untreated controls (FIG. 9). The combination of the ascaroside and the conventional fungicides provided additional protection from Asian Soybean Rust as compared with application of the fungicide alone or the ascaroside alone (FIGS. 9 and 10). The combination of ascarosides with conventional fungicide resulted in improved yield relative to conventional fungicide treatment alone (FIGS. 7 and 8).

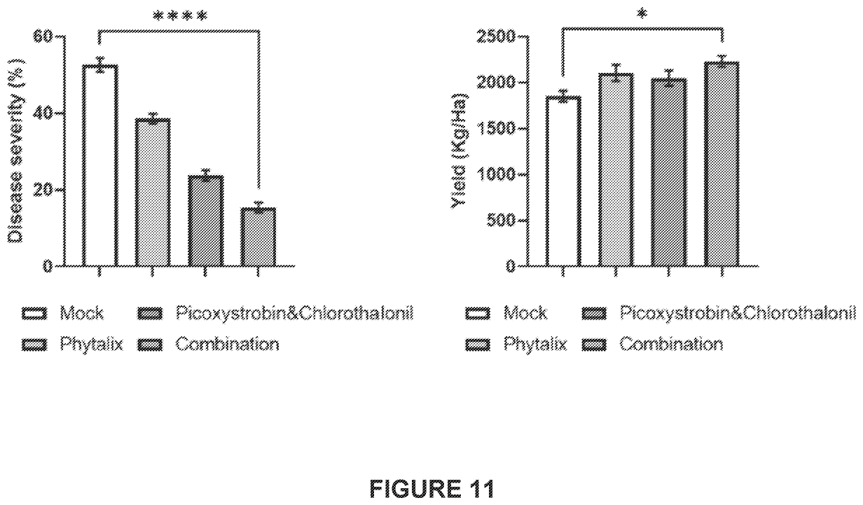

Example 9: A composition comprising a commercial ascaroside formulation PHYTALIX® and a commercial fungicide containing a blend of the strobilurin fungicide Picoxystrobin and Chlorothalonil was applied via foliar spray to soybean plants grown under field conditions. The composition was applied at a rate equivalent to the label rate for the commercial fungicide and 205 mg/ac of ascaroside. Three control groups were treated with: 1) a mock composition containing no fungicide or ascaroside, 2) a composition containing only commercial fungicide (at the label rate), and 3) containing only the ascaroside composition (at 205 mg/ac equivalent). As shown in FIG. 11, the combination treatment reduced disease symptoms more effectively than either ascarosides alone or commercial fungicide alone.

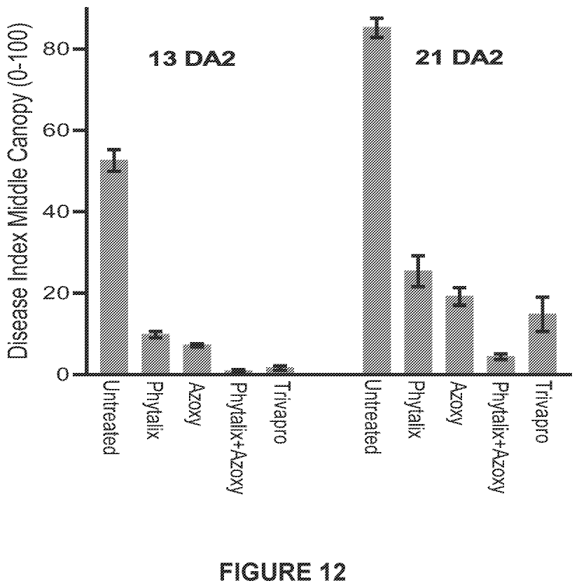

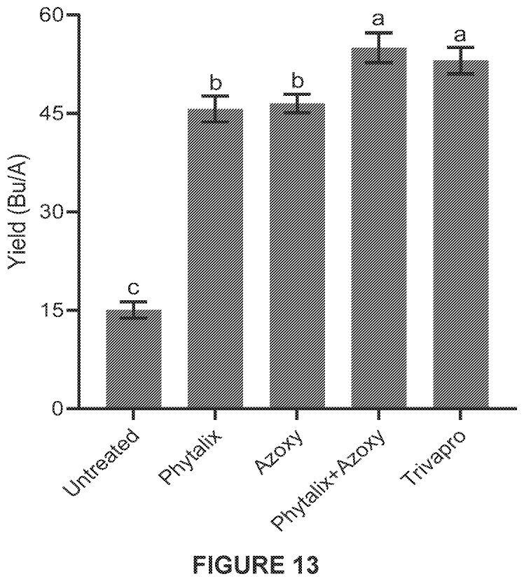

Example 10: A composition comprising a blend of an ascaroside formulation PHYTALIX® and a commercial formulation of the strobilurin fungicide Azoxystrobin was applied via foliar spray to soybean plants grown under field conditions and inoculated with Asian Soybean Rust. The composition was applied at a rate equivalent to the label rate for the commercial fungicide and 50 mg/ac of ascaroside. Four control groups were treated with 1) no fungicide or ascaroside, 2) only the azoxystrobin fungicide (at the label rate), and 3) only the ascaroside composition (at 50 mg/ac equivalent), and 4) only with Trivapro, a best-in-class commercial fungicide that contains a 3-way blend of Propiconazole, Azoxystrobin, Benzovindiflupyr. As shown in FIGS. 12 and 13, the ascaroside combination treatment reduced disease symptoms and increased yield more effectively than ascarosides alone or commercial fungicide alone and was superior to the best in class 3-way blend.

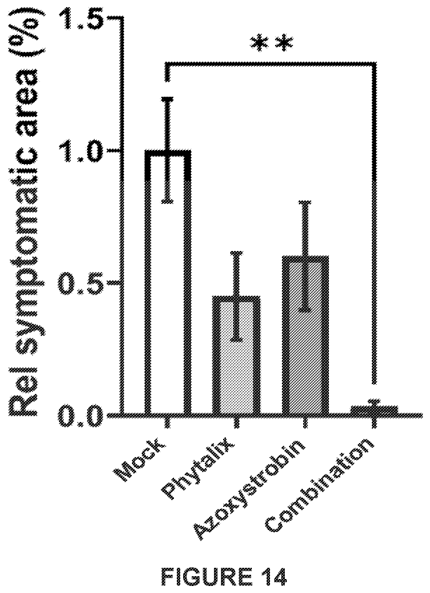

Example 11: A composition comprising a blend of an ascaroside formulation PHYTALIX® and a commercial formulation of the strobilurin fungicide Azoxystrobin was applied via foliar spray to wheat plants grown in a growth chamber and inoculated with Bipolaris sorokiniana the fungal pathogen responsible for Blotch Spot disease. A blend containing a commercial Azoxystrobin composition diluted to provide an application rate equivalent to 1/20^{th} of the standard label application rate and an ascaroside composition (PHYTALIX®) at a concentration equivalent to application of 25 mg of ascaroside per acre showed excellent disease control (FIG. 14, right column). Three control groups were included for comparison: 1) no fungicide or ascaroside treatment (mock), 2) only the azoxy strobin fungicide at 1/20th label rate (Azoxystrobin), and 3) only the ascaroside composition at 25 mg/ac equivalent (PHYTALIX®). These data (FIG. 14) demonstrate synergy between the ascaroside composition and the strobilurin Azoxystrobin and confirm that including ascarosides in such a blend enables reduction of the amount of fungicide. Notably, the blend shows the highest level of pathogen suppression, indicating that resistance development is unlikely.

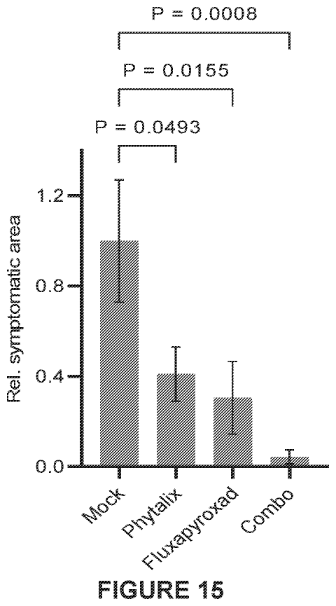

Example 12: A composition comprising a blend of an ascaroside formulation PHYTALIX® and a commercial formulation of the SDHI fungicide Fluxapyroxad was applied via foliar spray to wheat plants grown in a growth chamber and inoculated with Bipolaris sorokiniana the fungal pathogen responsible for Blotch Spot disease. A blend containing a commercial Fluxapyroxad composition diluted to provide an application rate equivalent to 1/₂₀th of the standard label application rate and an ascaroside composition (PHYTALIX®) at a concentration equivalent to application of 25 mg of ascaroside per acre showed excellent disease control (FIG. 15. Fluxapyroxad right column). Three control groups were included for comparison: 1) no fungicide or ascaroside treatment (mock), 2) only the SDHI fungicide at 1/20th label rate (Fluxapyroxad), and 3) only the ascaroside composition at 25 mg/ac equivalent (PHYTALIX®). These data demonstrate synergy between the ascaroside composition and the SDHI Fluxapyroxad and confirm that including ascarosides in such a blend enables reduction of the amount of fungicide. Notably, the blend shows the highest level of pathogen suppression, indicating that resistance development is unlikely.

Example 13: Stability of combinations of PHYTALIX® with various other commercial fungicide products was studied. Two sets of samples were produced to replicate tank mix formulations (e.g., PHYTALIX®and commercial product, diluted into water at their label rates and formulated blends where PHYTALIX®concentrate is added directly to the formulated commercial product. Samples were stored at room temperature and at 40° C. (for accelerated aging) and PHYTALIX®content was monitored periodically using HPLC/MS quantification. Results for 6 months are summarized below. The data surprisingly demonstrates that PHYTALIX® combinations with commercial fungicides in both concentrated formulations and at tank mix concentration are stable (e.g., with respect to ascaroside content) with a shelf life of at least 6 months or at least 12 months, despite the incredibly low ascaroside content present in each formulation. This finding is particularly surprising in light of the fact that generally, formulating mixtures of chemical and biological components can be rather challenging due to issues with incompatibility of such components with one another.

TABLE 1
Stability of Ascaroside-Containing Combination
Formulations over 6 months

| | Stability | | Stability in | |
|---|---|---|---|---|
| Agrochemical | in tank mix | | formulation | |
| (in combination with PHYTALIX ®) | RT | 40° C. | RT | 40° C. |
| MIRAVIS ® ACE (comprising | X | X | X | X |
| pydiflumetofen, propiconazole) | | | | |
| PROSARO ® (comprising | X | X | X | X |
| prothioconazole, tebuconazole) | | | | |
| CARAMBA ® (comprising | X | X | X | X |
| metconazole) | | | | |
| PROLINE ® (comprising | X | X | X | X |
| prothioconazole) | | | | |
| PRIAXOR ® (comprising fluxapyroxad | X | X | X | X |
| and pyraclostrobin) | | | | |
| STRATEGO ® (comprising | X | X | X | X |
| propiconazole and Trifloxystrobin) | | | | |
| APPROACH ® (comprising | X | X | X | X |
| picoxystrobin) | | | | |
| MICROP ® (comprising azoxystrobin | X | Not | X | Not |
| and propiconazole) | | Stable | | Stable |
| RELIANT ® (comprising mono- and di- | X | X | X | X |
| potassium salts of phosphorous acid) | | | | |

TABLE 2
Stability of Ascaroside-Containing Combination
Formulations over 12 months

| | Stability | | Stability in | |
|---|---|---|---|---|
| Agrochemical | in tank mix | | formulation | |
| (in combination with PHYTALIX ®) | RT | 40° C. | RT | 40° C. |
| MIRAVIS ® ACE (comprising | X | X | X | X |
| pydiflumetofen, propiconazole) | | | | |
| PROSARO ® (comprising | X | X | X | X |
| prothioconazole, tebuconazole) | | | | |
| CARAMBA ® (comprising | X | X | X | X |
| metconazole) | | | | |
| PROLINE ® (comprising | X | X | X | X |
| prothioconazole) | | | | |
| PRIAXOR ® (comprising fluxapyroxad | X | X | X | X |
| and pyraclostrobin) | | | | |
| STRATEGO ® (comprising | X | X | X | X |
| propiconazole and Trifloxystrobin) | | | | |
| APPROACH ® (comprising | X | X | X | X |
| picoxystrobin) | | | | |
| MICROP ® (comprising azoxystrobin | X | Not | X | Not |
| and propiconazole) | | Stable | | Stable |
| RELIANT ® (comprising mono- and di- | X | X | X | X |
| potassium salts of phosphorous acid) | | | | |

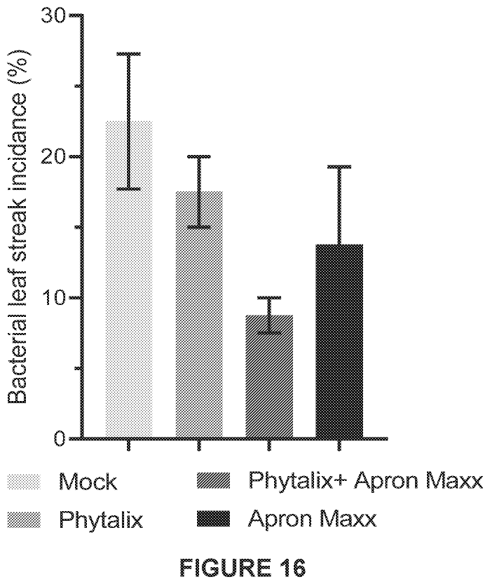

Example 14: A field trial was conducted to evaluate the efficacy of ascaroside seed treatments alone and in combination with a multi-way commercial fungicidal seed treatment to control Bacterial Leaf Stripe in wheat. Prior to planting, wheat seeds were treated with a commercial ascaroside formulation PHYTALIX®R applied at 2.5 ppm rate alone or in combination with Apron Maxx™ (Mefenoxam, Fludioxonil) at label rate. Plots grown from mock treated seed and from seed treated only with Apron Maxx™ were included as controls. The incidence of Bacterial Leaf Streak in the treatment groups was scored 2 months after planting and the results are plotted in FIG. 16. As shown in FIG. 16, plots grown from seed treated with a combination of PHYTALIX R and Apron Maxx™ had the lowest incidence of Bacterial Leaf Streak, demonstrating additive and/or synergistic activity that exceeded either product alone for control of this pathogen in wheat.

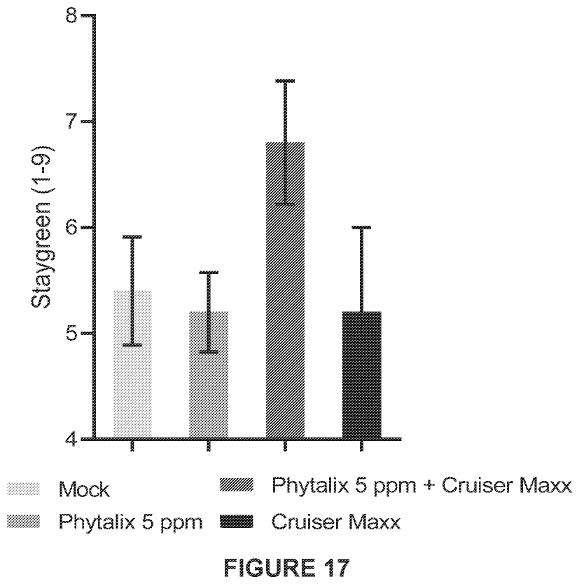

Example 15: A field trial was conducted to evaluate the efficacy of ascaroside seed treatments alone and in combination with a multi-way commercial fungicidal seed treatment to lengthen the photosynthetic period of corn. Prior to planting, corn seeds were treated with a commercial ascaroside formulation PHYTALIX® applied at 5 ppm rate alone or in combination with Apron Maxx™ (Mefenoxam, Fludioxonil) at label rate. Plots grown from mock treated seed and from seed treated only with Apron Maxx™ were included as controls. The Staygreen effect (scale 1-9) was measured 156 days after planting and the results are shown in FIG. 17. As shown in FIG. 17, the combination of PHYTALIX®and Apron Maxx™ showed the highest Staygreen score demonstrating additive and/or synergistic activity that exceeded either product alone.

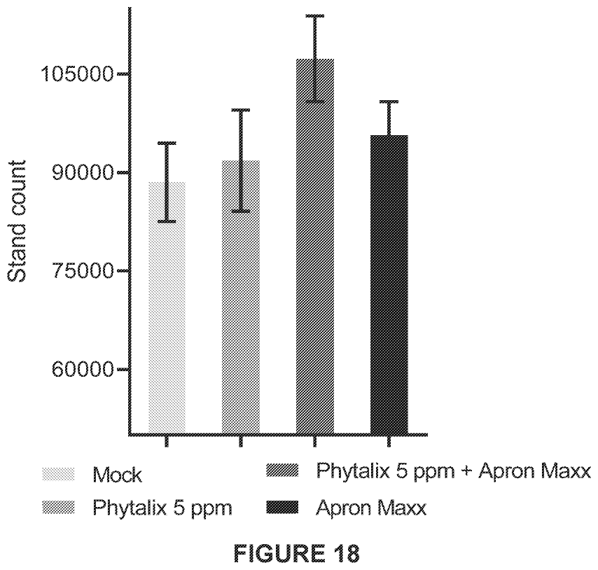

Example 16: A field trial was conducted to evaluate the efficacy of ascaroside seed treatments alone and in combination with a multi-way commercial fungicidal seed treatment to increase the germination and emergence of soybean seeds. Prior to planting, soybean seeds were treated with a commercial ascaroside formulation PHYTALIX®applied at 5 ppm rate alone, or in combination with Apron Maxx™ (Mefenoxam, Fludioxonil) applied at label rate. Plots grown from mock treated seed and from seed treated only with Apron Maxx™ were included as controls. The stand count in each plot was measured at 50% germination and extrapolated to the number seedlings per acre. The results are plotted in FIG. 18. As shown in FIG. 18, the combination of PHYTALIX®and Apron Maxx™ showed the highest stand counts demonstrating additive and/or synergistic activity that exceeded either product alone.

It is contemplated that compounds, compositions, and methods of the present application encompass variations and adaptations developed using information from the embodiments described in the present disclosure. Adaptation or modification of the methods and processes described in this specification may be performed by those of ordinary skill in the relevant art. It will be appreciated that use of headers in the present disclosure are provided for the convenience of the reader.

The presence and/or placement of a header is not intended to limit the scope of the subject matter described herein. Unless otherwise specified, embodiments located in one section of the application apply throughout the application to other embodiments, both singly and in combination. Throughout the description, where compositions, compounds, or products are described as having, including, or comprising specific components, or where processes and methods are described as having, including, or comprising specific steps, it is contemplated that, additionally, there are articles, devices, and systems of the present application that consist essentially of, or consist of, the recited components, and that there are processes and methods according to the present application that consist essentially of, or consist of, the recited processing steps. It should be understood that the order of steps or order for performing certain action is immaterial so long as the described method remains operable. Moreover, two or more steps or actions may be conducted simultaneously.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference. Although the foregoing invention has been described in some detail by way of illustration and example for purposes of clarity of understanding, it will be obvious that certain changes and modifications may be practiced within the scope of the appended claims.

What is claimed is:

1. A method of enhancing the activity of a fungicide, comprising co-administering to a plant, plant part, or soil surrounding the plant or plant part, the fungicide and one or more ascarosides.

2. The method of claim 1, wherein the fungicide is a biological fungicide.

3. The method of claim 1, wherein the fungicide is a chemical fungicide, selected from the group consisting of azoles, strobilurins, carboxamides, nitrogenous heterocyclyl compounds, carbamates and dithiocarbamates, guanidines, antibiotics, organometallic compounds, sulfur-containing heterocyclyl compounds, organophosphorus compounds, organochlorine compounds, nitrophenyl derivatives, inorganic active compounds, and combinations thereof.

4. A method of enhancing the activity of a fungicide, comprising co-administering to a plant, plant part, or soil surrounding the plant or plant part, the fungicide and one or more ascarosides,
a. wherein the fungicide comprises a triazole fungicide;
b. wherein the fungicide comprises a QₒI fungicide; or
c. wherein the fungicide comprises a SDHI fungicide

5. The method of claim 4, wherein the triazole fungicide is prothioconazole or tebuconazole.

6. The method of claim 4, wherein the QₒI fungicide is a strobilurin selected from the group consisting of Azoxystrobin, Picoxystrobin, Trifloxystrobin, Orysastrobin, Pyraclostrobin, Fenamistrobin, Dimoxystrobin, Fluoxastrobin, Metaminostrobin, Mandestrobin, Pyrametostrobin, Pyrazoxystrobin, Kresoxim-methyl, Fenamidone, or Famoxadone.

7. The method of claim 4, wherein the SDHI fungicide is a benzamide fungicide that inhibits succinate dehydrogenase (SDH) complex II, wherein the benzamide fungicide is selected from the group consisting of benodanil, flurenoxadiazam, flutolanil, mebenil, mepronil, fluopyram, benzohydroxamid acid, flumetover, flupicolide, flupimomoide, tioxymid, trichlamide, zarilamid, and zoxamide.

8. The method of claim 4, wherein the SDHI fungicide is a carboxamide fungicide that inhibits succinate dehydrogenase (SDH) complex II, and wherein the carboxamide fungicide is selected from the group consisting of:
an oxathiin fungicide;
a furan carboxamide fungicide;
a pyrazine carboxamide fungicide;
a pyrazole carboxamide fungicide; and
a pyridine carboxamide fungicide.

9. The method of claim 8, wherein the carboxamide fungicide is selected from the group consisting of carboxin, oxycarboxin, fenfuram, furcarbanil, methfuroxam, pyraziflumid, benzovindiflupyr, bixafen, flubeneteram, fluindapyr, fluxapyroxad, furametpyr, inpyrfluxam, isoflucypram, isopyrazam, penflufen, penthiopyrad, pydiflumetofen, pyrapropoyne, sedaxane, ethaboxam, thifluzamide, boscalid, and cyclobutrifluram

10. The method of claim 4, wherein the SDHI fungicide comprises a thiopheneamide fungicide, and wherein the thiopheneamide fungicide is isofetamid.

11. The method of any of claims 1-10, providing increased overall yield of the plant, wherein the increased overall yield of the plant is greater than yield of a plant treated with the fungicide alone plus yield of a plant treated with the one or more ascarosides alone.

12. The method of any of claims 1-11, providing increased disease protection, wherein the increased disease protection is greater than disease protection provided by treatment with the fungicide alone plus disease protection provided by treatment with the one or more ascarosides alone.

13. The method of any of claims 1-12, wherein the co-administering comprises applying the fungicide and the one or more ascarosides in the form of separate formulations.

14. The method of any of claims 1-12, wherein the co-administering comprises applying the fungicide and the one or more ascarosides in the form of a single formulation.

15. The method of any of claims 1-14, wherein the one or more ascarosides have the structure (I) 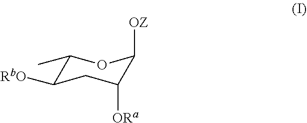
where:
Z is an optionally substituted C₂₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g., a moiety —C(O)OR^{c}), a C₂₋₂₀ carbamate (e.g., a moiety —C(O)N(R^{c})₂), a C₂₋₂₀ thioester (e.g., a moiety —C(S)R^{c}), a C₂₋₂₀ thiocarbonate (e.g., a moiety —C(S)OR^{c}), a C₂₋₂₀ dithiocarbonate (e.g., a moiety —C(S)SR^{c}), a C₁₋₂₀ thiocarbamate (e.g., a moiety —C(S)N(R^{c})₂), a sugar moiety, a peptide, a polymer chain, or a linkage via a bond or a carbon-containing linker moiety to another ascaroside molecule, where R^{c} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

16. The method of claim 15, wherein Z is selected from the group consisting of:
i. —CH(CH₃)—R¹, where R¹ is an optionally substituted C₁₋₄₀ aliphatic group;
ii. —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
iii. —CH(CH₃)—(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
iv. —CH(CH₃)—(CH₂)ₙ—CH(OH)—CH—CO₂R², where n is an integer from 1 to 40, and R² is —H, a metal cation, an optionally substituted C₁₋₂₀ aliphatic group, an optionally substituted C₁-₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
v. —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
vi. —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
vii. —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
viii. —(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule; and
ix. —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule,
x. —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xi. —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xii. —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xiii. —CH(CH₃)—(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xiv. —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xv. —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xvi. —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; and
xvii. —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

17. The method of any one of claims 1 to 16, wherein the one or more ascarosides comprises ascr #18.

18. A composition comprising one or more ascarosides and one or more fungicides.

19. The composition of claim 18, wherein the one or more fungicides comprises a biological fungicide.

20. The composition of claim 18, wherein the one or more fungicides comprises a chemical fungicide selected from the group consisting of azoles, strobilurins, carboxamides, nitrogenous heterocyclyl compounds, carbamates and dithiocarbamates, guanidines, antibiotics, organometallic compounds, sulfur-containing heterocyclyl compounds, organophosphorus compounds, organochlorine compounds, nitrophenyl derivatives, inorganic active compounds, and combinations thereof.

21. A composition comprising one or more ascarosides and one or more fungicides,
a. wherein the one or more fungicides comprises a triazole fungicide;
b. wherein the one or more fungicides comprises a QₒI fungicide; or
c. wherein the one or more fungicides comprises a SDHI fungicide.

22. The composition of claim 21, wherein the triazole fungicide is prothioconazole or tebuconazole.

23. The composition of claim 21, wherein the QₒI fungicide is a strobilurin selected from the group consisting of Azoxystrobin, Picoxystrobin, Trifloxystrobin, Orysastrobin, Pyraclostrobin, Fenamistrobin, Dimoxystrobin, Fluoxastrobin, Metaminostrobin, Mandestrobin, Pyrametostrobin, Pyrazoxystrobin, Kresoxim-methyl, Fenamidone, and Famoxadone.

24. The composition of claim 21, wherein the SDHI fungicide is a benzamide fungicide that inhibits succinate dehydrogenase (SDH) complex II, wherein the benzamide fungicide is selected from the group consisting of benodanil, flurenoxadiazam, flutolanil, mebenil, mepronil, fluopyram, benzohydroxamid acid, flumetover, flupicolide, flupimomoide, tioxymid, trichlamide, zarilamid, and zoxamide.

25. The composition of claim 21, wherein the SDHI fungicide is a carboxamide fungicide that inhibits succinate dehydrogenase (SDH) complex II, and wherein the carboxamide fungicide is selected from the group consisting of:
an oxathiin fungicide;
a furan carboxamide fungicide;
a pyrazine carboxamide fungicide;
a pyrazole carboxamide fungicide; and
a pyridine carboxamide fungicide.

26. The composition of claim 25, wherein the carboxamide fungicide is selected from the group consisting of carboxin, oxycarboxin, fenfuram, furcarbanil, methfuroxam, pyraziflumid, benzovindiflupyr, bixafen, flubeneteram, fluindapyr, fluxapyroxad, furametpyr, inpyrfluxam, isoflucypram, isopyrazam, penflufen, penthiopyrad, pydiflumetofen, pyrapropoyne, sedaxane, ethaboxam, thifluzamide, boscalid, and cyclobutrifluram

27. The composition of claim 21, wherein the SDHI fungicide comprises a thiopheneamide fungicide, and wherein the thiopheneamide fungicide is isofetamid.

28. The composition of any of claims 18-27, wherein the at least one ascaroside and the fungicide are present in an effective amount, and wherein the effective amount provides synergistic activity in controlling fungal disease.

29. The composition of any of claims 18-28, wherein the one or more ascarosides have the structure (I) 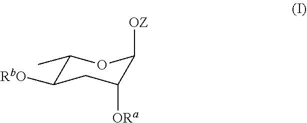
where:
Z is an optionally substituted C₃₋₄₀ aliphatic group, and
each of R^{a} and R^{b} is independently —H, or an optionally substituted moiety selected from the group consisting of: C₁₋₂₀ aliphatic, C₁₋₂₀ acyl, C₁₋₂₀ heteroaliphatic, aryl, heteroaryl, a hydroxyl protecting group, a phosphorous-linked functional group, a sulfur-linked functional group, a silicon-linked functional group, a C₂₋₂₀ carbonate (e.g. -a moiety —C(O)OR^{c}), a C₂₋₂₀ carbamate (e.g. -a moiety —C(O)N(R^{c})₂), a C₂₋₂₀ thioester (e.g. a moiety —C(S)R^{c}), a C₂₋₂₀ thiocarbonate (e.g. a moiety —C(S)OR^{c}), a C₂₋₂₀ dithiocarbonate (e.g. a moiety —C(S)SR^{c}), a C₁₋₂₀ thiocarbamate (e.g. a moiety —C(S)N(R^{c})₂), a sugar moiety, a peptide, a polymer chain, or a linkage via a bond or a carbon-containing linker moiety to another ascaroside molecule, where R^{o} is independently at each occurrence selected from —H, optionally substituted C₁₋₁₂ aliphatic, optionally substituted C₁₋₁₂ heteroaliphatic, optionally substituted aryl, optionally substituted heteroaryl, a polymer chain, or a linkage via a bond or a carbon-containing linker moiety to another ascaroside molecule, and where R^{a} and R^{b} may be taken together to form an optionally substituted ring, optionally containing one or more heteroatoms, and optionally containing one or more sites of unsaturation.

30. The composition of claim 29, wherein Z is selected from the group consisting of:
i. —CH(CH₃)—R¹, where R¹ is an optionally substituted C₁₋₄₀ aliphatic group;
ii. —CH(CH₃)—(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
iii. —CH(CH₃)—(CH₂)—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
iv. —CH(CH₃)—(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
v. —CH(CH₃)—(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
vi. —(CH₂)ₙ—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
vii. —(CH₂)ₙ—CH═CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
viii. —(CH₂)ₙ—CH(OH)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule;
ix. —(CH₂)ₙ—C(O)—CH—CO₂R², where n is an integer from 1 to 40, and R² is —H, a metal cation, an optionally substituted C₁₋₂₀ aliphatic group, an optionally substituted C₁₋₂₀ heteroaliphatic group, an optionally substituted aromatic group, an optionally substituted heteroaryl group, a glycoside, an amino acid, a peptide, a nucleotide, or a linkage via a bond or a carbon-containing linker moiety to another ascaroside molecule,
x. —CH(CH₃)—(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xi. —CH(CH₃)—(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xii. —CH(CH₃)—(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xiii. —CH(CH₃)—(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xiv. —(CH₂)ₙ—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xv. —(CH₂)ₙ—CH═CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule;
xvi. —(CH₂)ₙ—CH(OH)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule; and
xvii. —(CH₂)ₙ—C(O)—CH—CON(R³)₂, where n is an integer from 1 to 40, and each R³ is independently —H, an optionally substituted C₁₋₂₀ aliphatic group, an optionally substituted C₁₋₂₀ heteroaliphatic group, an optionally substituted aromatic group, an optionally substituted heteroaryl group, a polymer chain, an amino acid, a peptide, a nucleotide, or a linkage via a bond or a carbon-containing linker moiety to another ascaroside molecule.

31. The composition of any one of claims 18-30, wherein the one or more ascarosides comprise ascr #18.

32. The composition of any of claims 18-31, in solid form.

33. The composition of claim 32, wherein the solid form comprises powder or granules.

34. The composition of any of claims 18-31, in liquid form.

35. The composition of claim 34, wherein the liquid form is a sprayable formulation.

36. The composition of claim 34 or 35, wherein the composition is shelf-stable for a period of greater than 6 months.

37. The composition of any of claims 18-36, further comprising one or more additional components selected from the group consisting of surfactants, including emulsifiers, dispersants, foam-formers, colorants, processing aids, lubricants, fillers, reinforcements, flame retardants, light stabilizers, ultraviolet radiation absorbers, weather stabilizers, plasticizers, release agents, perfumes, heat-retaining additives (e.g., silica), cross-linking agents, antioxidants, anti-foaming agents, buffers, pH modifiers, compatibility agents, drift control additives, extenders/stickers, tackifiers, plant penetrants, safeners, spreaders, and wetting agents.

38. The composition of any of claims 18-37, wherein the fungicide and the ascaroside are present in a weight ratio of greater than 1000:1 fungicide:ascaroside.

39. The composition of any of claims 18-38, labeled for application to crops at a rate lower than a label rate of the fungicide alone.

40. The composition of any of claims 18-39, labeled for application to crops at a rate that delivers less than 4 oz of the fungicide per acre.
